(19) United States
(12) Patent Application Publication
(10) Pub. No.: US 2016/0131922 A1
(43) Pub. Date: May 12, 2016

(54) OPTICAL SYSTEM, OBSERVATION OPTICAL SYSTEM, AND OPTICAL APPARATUS

(71) Applicant: FUJIFILM Corporation, Tokyo (JP)

(72) Inventors: Akiko NAGAHARA, Saitama-shi (JP); Yukiko NAGATOSHI, Saitama-shi (JP)

(73) Assignee: FUJIFILM Corporation, Tokyo (JP)

(21) Appl. No.: 14/934,418

(22) Filed: Nov. 6, 2015

(30) Foreign Application Priority Data
Nov. 10, 2014 (JP) 2014-227708
Aug. 14, 2015 (JP) 2015-160088

(51) Int. Cl. G02B 27/64; G02B 23/18; G02B 23/02; G02B 26/08; G02B 17/00

(52) U.S. Cl. CPC G02B 27/646; G02B 26/0816; G02B 17/008; G02B 23/02; G02B 23/18

(57) ABSTRACT

In an optical system composed of, in order from the object side, an objective optical system and a reflective surface optical system disposed along the optical axis of the objective optical system, a first reflective surface is turned around a turning axis passing through the intersection between the first reflective surface and the optical axis and is perpendicular to the plane that includes the optical axes before and after being bent by the first reflective surface. Further, the first reflective surface and the second reflective surface are turned synchronously around turning axes, each passing through the intersection between each corresponding reflective surface with the optical axis, being deviated from the normal to each corresponding reflective surface, and being arranged in parallel to each other, whereby an image formed by the objective optical system is shifted to move the image location of the objective optical system.

### CROSS-REFERENCE TO RELATED APPLICATIONS

The present application claims priority under 35 U.S.C. §119 to Japanese Patent Application No. 2014-227708 filed on Nov. 10, 2014 and Japanese Patent Application No. 2015-160088 filed on Aug. 14, 2015. Each of the above applications is hereby expressly incorporated by reference, in its entirety, into the present application.

### BACKGROUND

The present disclosure relates to an optical system, and more particularly to an optical system provided with an image blur correction function, and includes an objective optical system and a reflective surface optical system disposed on the image side of the objective optical system.

The present disclosure also relates to an observation optical system which includes such an optical system, and further relates to an optical apparatus, such as a binocular scope, having such an observation optical system.

Heretofore, a monocular scope (field scope) having one telescope optical system, a binocular scope having a pair of telescope optical systems arranged in a left-right direction, and the like have been known, as optical observation devices for observing an optical image of distant view. In order to prevent an image blur of an optical image due to vibrations caused, for example, by camera shake, an optical device having an optical system for correcting an image blur of an optical image has also been known.

For example, an image blur correction optical system that corrects an image blur by driving an erecting prism provided in the telescope optical system, and an image blur correction optical system that corrects an image blur by driving a plurality of reflective mirrors are well-known as the image blur correction optical systems of optical devices. The image blur correction optical system that drives reflective mirrors has an advantage over the correction optical system that drives an erecting prism in that it is light weight and low cost.

Japanese Unexamined Patent Publication No. 10(1998)-333201 describes an optical observation device in which an image blur correction optical system having first to fourth reflective members is disposed between an objective optical system and an eyepiece optical system constituting a telescope optical system. The first to fourth reflective members are reflective mirrors. In the image blur correction optical system described in Japanese Unexamined Patent Publication No. 10(1998)-333201, the first optical axis of the objective optical system is deflected by the first reflective member to provide a second optical axis, which is then deflected by the second reflective member to provide a third optical axis, which is then deflected by the third reflective member to provide a fourth optical axis, which is then deflected by the fourth reflective member to provide a fifth optical axis that enters the eyepiece optical system. The second reflective member and the third reflective member are turnably movable reflective members, and it is possible to correct image blurs in a first direction (pitch direction) and a second direction (yaw direction) by independently turning the reflective members around two orthogonal turning axes respectively.

Japanese Unexamined Patent Publication No. 11(1999)-305276 describes an imaging optical system in which an image blur correction optical system having a first movable mirror and a second movable mirror is disposed on the image side of the imaging lens. The first movable mirror deflects the optical axis of the imaging lens upward, and the second movable mirror is oriented such that optical axis bent by the second movable mirror is deflected in a direction perpendicular to the plane which includes the optical axis of the imaging lens and the optical axis deflected by the first movable mirror. A film is disposed at the focal plane on the optical axis bent by the second movable mirror. The first and the second movable mirrors may independently turn to correct an image blur on the film surface due to the motion of the imaging device.

### SUMMARY

An image blur correction optical system built into an optical device, such as a binocular scope, is required to allow for easy of securing the installation space, fast in response speed, and small and lightweight for improving portability. The image blur correction optical system described in Japanese Unexamined Patent Publication No. 10(1998)-333201, however, requires four reflective members and the optical path becomes longer by the number of the reflective members, so that a problem is found that weight and size reduction is difficult.

It may be conceivable to configure an image blur correction optical system with only two movable reflective members, as in the image blur correction optical system described in Japanese Unexamined Patent Publication No. 11(1999)-305276. But, this configuration causes a problem that the direction of the optical axis of the imaging lens entering the image blur correction optical system is orthogonal to the direction of the optical axis exiting from the image blur correction optical system. One additional reflective surface is required to align the directions of the two optical axes, and the insertion of the additional reflective surface will result in an increased entire system structure. This is also disadvantageous in terms of cost.

In a case where the two reflective members are disposed in parallel to align the directions of the foregoing two optical axes and the two reflective members are turned respectively, under this state, as in Japanese Unexamined Patent Publication No. 11(1999)-305276, a problem may occur that the optical image is rotated to the extent that an appropriate image observation or imaging is impossible.

The present disclosure has been developed in view of the circumstances described above, and the present disclosure provides an optical system, a telescope optical system, and an optical apparatus which have a configuration to correct an image blur using reflective surfaces, in which the number of required reflective surfaces is suppressed by avoiding an increase in the number of reflective surfaces for aligning the direction of the optical axis entering the image blur correction optical system and the direction of the optical axis exiting from the image blur correction optical system, and allow appropriate image blur correction.

A first optical system according to the present disclosure includes, in order from the object side, an objective optical system and a reflective surface optical system disposed along the optical axis of the objective optical system, wherein:

the reflective surface optical system comprises a first reflective surface and a second reflective surface disposed in parallel to each other;

the first reflective surface includes a straight line perpendicular to the optical axis of the objective optical system and is capable of taking a reference state in which the first reflective surface is disposed such that a plane is formed by the optical axis after being reflected by the first reflective surface and the optical axis of the objective optical system;

the apparatus is configured such that the image location of the objective optical system is moved by one of the following operations:
a turning operation of either one of the first reflective surface and the second reflective surface around a turning axis A passing through the intersection between the reflective surface and the optical axis and is perpendicular to the plane that includes the optical axes before and after being bent by the reflective surface;
a turning operation of the first reflective surface and the second reflective surface synchronously around turning axes B1 and B2, each passing through the intersection between each corresponding reflective surface and the optical axis, being deviated from the normal to each corresponding reflective surface, and being arranged in parallel to each other; and
both of the turning operations; and

the following conditional expression is satisfied:

1.05<F/D<2.50 (1)

where:

F is the focal length of the objective optical system; and

D is the air equivalent length from the reflective surface that turns around the turning axis A to the focus position of the objective optical system on the reflective surface optical system side on the optical axis of the objective optical system.

With respect to the value of F/D, it is more preferable that the following conditional expression (1)′ is satisfied:

1.10<F/D<2.30 (1)′.

A second optical system according to the present disclosure includes, in order from the object side, an objective optical system and a reflective surface optical system disposed along the optical axis of the objective optical system, wherein:

the reflective surface optical system comprises a first reflective surface and a second reflective surface disposed in parallel to each other;

the first reflective surface includes a straight line perpendicular to the optical axis of the objective optical system and is capable of taking a reference state in which the first reflective surface is disposed such that a plane is formed by the optical axis after being reflected by the first reflective surface and the optical axis of the objective optical system;

the apparatus is configured such that the image location of the objective optical system is moved by one of the following operations:
a turning operation of either one of the first reflective surface and the second reflective surface around a turning axis A passing through the intersection between the reflective surface and the optical axis and is perpendicular to the plane that includes the optical axes before and after being bent by the reflective surface;
a turning operation of the first reflective surface and the second reflective surface synchronously around turning axes B1 and B2, each passing through the intersection between each corresponding reflective surface and the optical axis, being deviated from the normal to each corresponding reflective surface, and being arranged in parallel to each other; and
both of the turning operations; and

the following conditional expression is satisfied:

3.50<F/d<6.00 (2)

where:

F is the focal length of the objective optical system; and

d is the air equivalent length between the first reflective surface and the second reflective surface on the optical axis of the objective optical system.

With respect to the value of F/d, it is more preferable that the following conditional expression (2)′ is satisfied:

3.80<F/d<5.50 (2)′.

A third optical system according to the present disclosure includes, in order from the object side, an objective optical system and a reflective surface optical system disposed along the optical axis of the objective optical system, wherein:

the reflective surface optical system comprises a first reflective surface and a second reflective surface disposed in parallel to each other;

the first reflective surface includes a straight line perpendicular to the optical axis of the objective optical system and is capable of taking a reference state in which the first reflective surface is disposed such that a plane is formed by the optical axis after being reflected by the first reflective surface and the optical axis of the objective optical system;

the apparatus is configured such that the image location of the objective optical system is moved by one of the following operations:
a turning operation of either one of the first reflective surface and the second reflective surface around a turning axis A passing through the intersection between the reflective surface and the optical axis and is perpendicular to the plane that includes the optical axes before and after being bent by the reflective surface;
a turning operation of the first reflective surface and the second reflective surface synchronously around turning axes B1 and B2, each passing through the intersection between each corresponding reflective surface and the optical axis, being deviated from the normal to each corresponding reflective surface, and being arranged in parallel to each other; and
both of the turning operations; and

the following conditional expression is satisfied:

0.70<φDia/H<1.50 (3)

where:

φDia is the maximum effective diameter of the axial light beam on the most object side surface of the objective optical system; and

H is the amount of displacement of the optical axis by the first reflective surface and the second reflective surface.

With respect to the value of φDia/H, it is more preferable that the following conditional expression (3)′ is satisfied:

0.78<φDia/H<1.35 (3)′.

A fourth optical system according to the present disclosure includes, in order from the object side, an objective optical system and a reflective surface optical system disposed along the optical axis of the objective optical system, wherein:

the reflective surface optical system comprises a first reflective surface and a second reflective surface disposed in parallel to each other;

the first reflective surface includes a straight line perpendicular to the optical axis of the objective optical system and is capable of taking a reference state in which the first reflective surface is disposed such that a plane is formed by the optical axis after being reflected by the first reflective surface and the optical axis of the objective optical system;

the apparatus is configured such that the image location of the objective optical system is moved by one of the following operations:
a turning operation of either one of the first reflective surface and the second reflective surface around a turning axis A passing through the intersection between the reflective surface and the optical axis and is perpendicular to the plane that includes the optical axes before and after being bent by the reflective surface;
a turning operation of the first reflective surface and the second reflective surface synchronously around turning axes B1 and B2, each passing through the intersection between each corresponding reflective surface and the optical axis, being deviated from the normal to each corresponding reflective surface, and being arranged in parallel to each other; and
both of the turning operations; and

the following conditional expression is satisfied:

0.00<(H−φDia/2)/dm1<0.70 (12)

where:

H is the amount of displacement of the optical axis by the first reflective surface and the second reflective surface;

φDia is the maximum effective diameter of the axial light beam on the most object side surface of the objective optical system; and

dm1 is the length from the most object side surface of the objective optical system to the first reflective surface on the optical axis of the objective optical system.

With respect to the value of (H−φDia/2)/dm1, it is more preferable that the following conditional expression (12)′ is satisfied, and further more preferable that the following conditional expression (12)″ is satisfied:

0.00<(H−φDia/2)/dm1<0.40 (12)′

0.10<(H−φDia/2)/dm1<0.35 (12)″.

The term “optical system of the present disclosure” or “optical system according to the present disclosure” as used hereinafter refers to include all of the first, second, third, and fourth optical systems.

Preferably, the foregoing conditional expression (2) is satisfied also in the first optical system.

It is more preferable that the foregoing conditional expression (3), as well as the conditional expression (2), is satisfied in the first optical system.

Preferably, the foregoing conditional expression (3) is satisfied in the first optical system.

Preferably, the foregoing conditional expression (12) is satisfied in the first optical system.

Preferably, the foregoing conditional expression (3) is satisfied in the second optical system.

Preferably, the foregoing conditional expression (12) is satisfied in the third optical system.

In the optical system of the present disclosure, it is preferable that at least one optical plane is present further to the side of the image location formed by the objective optical system than the member constituting the second reflective surface, and the following conditional expression is satisfied:

1.50<Lair/φDia<3.50 (4)

where:

Lair is the length between the most image side surface of the objective optical system and the optical plane located closest to the second reflective surface among the optical planes; and

φDia is the maximum effective diameter of the axial light beam on the most object side surface of the objective optical system.

With respect to the value of Lair/φDia, it is more preferable that the following conditional expression (4)′ is satisfied:

1.80<Lair/φDia<3.30 (4)′.

The foregoing “optical surface” may be any of refractive surface, reflective surface, and diffractive surface, and specific examples of optical elements having such optical surfaces include filters, prisms, mirrors, lenses, diffraction gratings, and the like. Note that the imaging plane of the objective optical system is also included in the optical surfaces. On the other hand, the aperture of a stop is not included in the optical surfaces.

In the optical system of the present disclosure, the first reflective surface and the second reflective surface are preferably inclined by 45° with respect to the optical axis of the objective optical system under a state in which no turning operation is performed.

An observation optical system according to the present disclosure includes any one of the foregoing optical systems of the present disclosure, and an eyepiece optical system disposed behind the second reflective surface (on the side of the second reflective surface where image location formed by the objective optical system is located).

In the observation optical system according to the present disclosure, an erecting optical system is preferably disposed between the second reflective surface and the eyepiece optical system.

As such erecting optical system, an erecting optical system composed of a type II Porro prism may suitably be used.

In the observation optical system according to the present disclosure, the following conditional expression is preferably satisfied:

0.30<Dair/F<0.70 (5)

where:

Dair is the length between the most image side surface of the objective optical system and the surface of the erecting optical system located closest to the second reflective surface; and

F is the focal length of the objective optical system.

With respect to the value of Dair/F, it is more preferably that the following conditional expression (5)′ is satisfied:

0.37<Dair/F<0.62 (5)′.

Further, it is preferable that in the observation optical system according to the present disclosure, at least either one of a first light shielding member to be disposed between the objective optical system and the second reflective surface and a second light shielding member to be disposed between the first reflective surface and the erecting optical system is provided, and at least one of the following conditional expressions is satisfied when the following are assumed:

in a coordinate system with a surface which includes the optical axes before and after being bent by the first reflective surface under the reference state as the coordinate surface and the position of the optical axis on the first reflective surface as the origin, in which the direction of the optical axis from the first reflective surface toward the second reflective surface is +y direction and the direction of the optical axis from the objective optical system toward the first reflective surface is +z direction,

a tip point of the first light shielding member on the optical axis side between the objective optical system and the first reflective surface as M (ym, zm);

a tip point of the second light shielding member on the optical axis side between the second reflective surface and the erecting optical system as N (yn, zn);

an intersection having the largest y-coordinate of those between rays at a viewing angle of 0 degree and the most image side surface of the objective optical system as P1 (y1, z1);

an intersection having the smallest z-coordinate of those between rays at a viewing angle of 0 degree and the second reflective surface as P2 (y2, z2);

an intersection having the largest z-coordinate of those between rays at a viewing angle of 0 degree and the first reflective surface as P3 (y3, z3); and

an intersection having the smallest y-coordinate of those between rays at a viewing angle of 0 degree and the surface of the erecting optical system located closest to the second reflective surface as P4 (y4, z4),

y3<ym<y1 (6)

z1<zm<z2 (7)

y2<yn<y4 (8)

z3<zn<z4 (9).

In this case, the following conditional expressions are preferably satisfied:

0.08<(z2−zm)/(z2−z1)<1.00 (10)

0.08<(zn−z3)/(z4−z3)<1.00 (11).

With respect to the value of (z2−zm)/(z2−z1), it is more preferable that the following conditional expression (10)′ is satisfied and further more preferable that the following conditional expression (10)″ is satisfied:

0.20<(z2−zm)/(z2−z1)<1.00 (10)′

0.27<(z2−zm)/(z2−z1)<1.00 (10)″.

With respect to the value of (zn−z3)/(z4−z3), it is more preferable that the following conditional expression (11)′ is satisfied and further more preferable that the following conditional expression (11)″ is satisfied:

0.20<(zn−z3)/(z4−z3)<1.00 (11)′

0.27<(zn−z3)/(z4−z3)<1.00 (11)″.

An optical apparatus according to the present disclosure includes the observation optical system described above. An example of such optical apparatus may be a binocular scope.

As described above, the optical system according to the present disclosure includes a reflective surface optical system in which a first reflective surface and a second reflective surface are disposed in parallel to each other, the first reflective surface includes a straight line perpendicular to the optical axis of the objective optical system and is capable of taking a reference state in which the first reflective surface is disposed such that a plane is formed by the optical axis after being reflected by the first reflective surface and the optical axis of the objective optical system, and the apparatus is configured such that the image location of the objective optical system is moved by one of the following operations: a turning operation of either one of the first reflective surface and the second reflective surface around a turning axis A passing through the intersection between the reflective surface and the optical axis and is perpendicular to the plane that includes the optical axes before and after being bent by the reflective surface; a turning operation of the first reflective surface and the second reflective surface synchronously around turning axes B1 and B2, each passing through the intersection between each corresponding reflective surface and the optical axis, being deviated from the normal to each corresponding reflective surface, and being arranged in parallel to each other; and both of the turning operations. This allows an image formed by the objective optical system to be shifted in one direction by the former operation and in a direction intersecting the one direction by the latter operation, thereby allowing the image to be shifted in any direction, so that an appropriate image blur correction may be made.

As the optical system according to the present disclosure may obtain the foregoing advantageous effect with the use of only two reflective surfaces, a size increase may be avoided and is advantageous in terms of cost. More specifically, in the optical system according to the present disclosure, the first reflective surface and the second reflective surface constituting the reflective surface optical system for image blur correction are disposed in parallel to each other under the reference state in which no operation for moving the image location of the objective optical system is performed. Therefore, the optical axis entering the reflective surface optical system and the optical axis exiting from the reflective surface optical system are naturally parallel. Thus, no other reflective surface is required to align the two axes, which may avoid a size increase of the optical system of the present disclosure and is advantageous in terms of cost.

According to the first optical system of the present disclosure, in particular, the conditional expression (1) is satisfied. This makes it easy to prevent interference between the first reflective surface or the second reflective surface and the objective optical system and allows the ratio of the image shift amount with respect to the turning angle of the first reflective surface or the second reflective surface to be increased. The detailed reason will be described in detail later with reference to the embodiments.

According to the second optical system of the present disclosure, in particular, the conditional expression (2) is satisfied. This also makes it easy to prevent interference between the first reflective surface or the second reflective surface and the objective optical system and allows the ratio of the image shift amount with respect to the turning angle of the first reflective surface or the second reflective surface to be increased. The detailed reason will be described in detail later with reference to the embodiments.

According to the third optical system of the present disclosure, in particular, the conditional expression (3) is satisfied. This makes it easy to prevent stray light escaping without passing the first reflective surface or the second reflective surface and allows the optical system to be made more compact by suppressing the length of the optical system (length in a direction of the optical axis extending between the first reflective surface and the second reflective surface). The detailed reason will be described in detail later with reference to the embodiments.

According to the fourth optical system of the present disclosure, in particular, the conditional expression (12) is satisfied. This allows a configuration with reduced thicknesses in optical axis shifting directions (directions in which the optical axis is displaced by the first reflective surface and the second reflective surface) while preventing stray light escaping without passing the first reflective surface or the second reflective surface. The detailed reason will be described in detail later with reference to the embodiments.

As the observation optical system and the optical apparatus according to the present disclosure are equipped with the optical system of the present disclosure, it is possible to obtain the same advantageous effects as described above.

### BRIEF DESCRIPTION OF THE DRAWINGS

FIG. 1 is a schematic perspective view of an observation optical system according to one embodiment of the present disclosure.

FIG. 2 is a drawing for explaining an arrangement state of some optical elements of the observation optical system of FIG. 1.

FIG. 3 is a cross-sectional view of an observation optical system according to Example 1 of the present disclosure.

FIG. 4 is a cross-sectional view of an observation optical system according to Example 2 of the present disclosure.

FIG. 5 is a cross-sectional view of an observation optical system according to Example 3 of the present disclosure.

FIG. 6 is a cross-sectional view of an observation optical system according to Example 4 of the present disclosure.

FIG. 7 is a cross-sectional view of an observation optical system according to Example 5 of the present disclosure.

FIG. 8 is a cross-sectional view of an observation optical system according to Example 6 of the present disclosure.

FIG. 9 is a plan view of an optical apparatus according to one embodiment of the present disclosure.

FIG. 10 is a side view of the optical apparatus shown in FIG. 9.

FIG. 11 is a block diagram of the optical apparatus shown in FIG. 9, illustrating the structure involved in the image blur correction control.

FIG. 12 is a cross-sectional view of an observation optical system according to Example 7 of the present disclosure.

FIG. 13 is a cross-sectional view of an observation optical system according to Example 8 of the present disclosure.

FIG. 14 is a cross-sectional view of an observation optical system according to Example 9 of the present disclosure.

FIG. 15 is a cross-sectional view of an observation optical system according to Example 10 of the present disclosure.

FIG. 16 is a cross-sectional view of an observation optical system according to Example 11 of the present disclosure.

FIG. 17 is a cross-sectional view of an observation optical system according to Example 12 of the present disclosure.

FIG. 18 is a cross-sectional view of an observation optical system according to Example 13 of the present disclosure.

FIG. 19 is a schematic view of an observation optical system of the present disclosure, illustrating an operation thereof.

FIG. 20 is a schematic view of an observation optical system of the present disclosure, illustrating an operation thereof.

FIG. 21 is a schematic view of an observation optical system of the present disclosure, illustrating an operation thereof

### DETAILED DESCRIPTION OF THE PREFERRED EMBODIMENTS

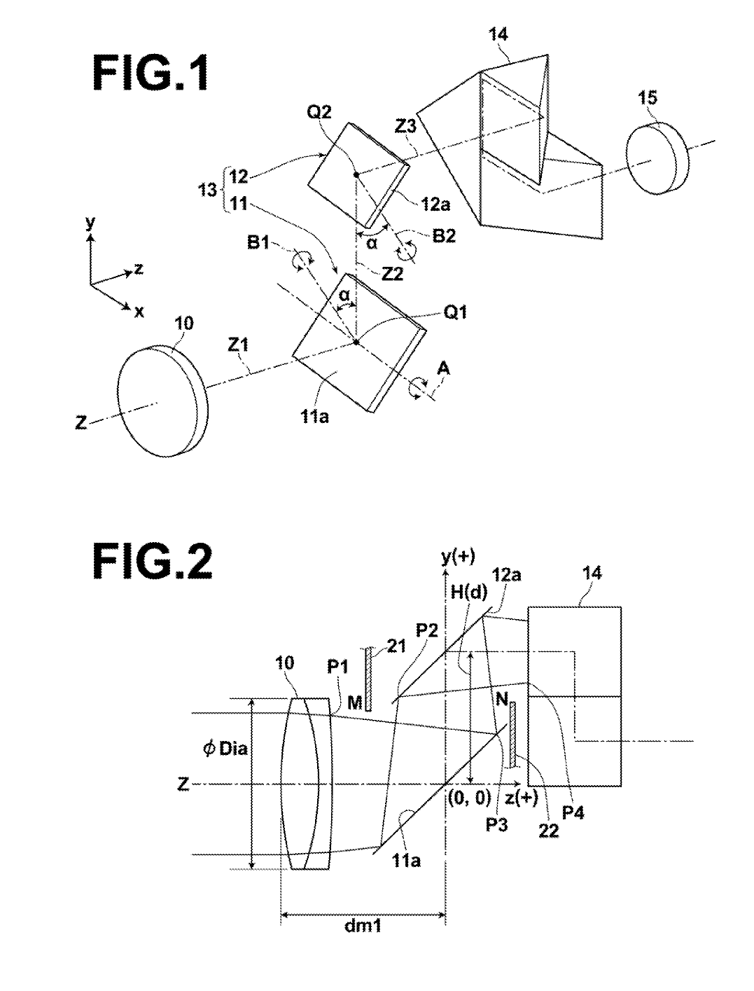

Hereinafter, embodiments of the present disclosure will be described in detail with reference to the accompanying drawings. FIG. 1 is a perspective view of an optical system according to one embodiment of the present disclosure, illustrating a configuration example. The optical system of the present embodiment is configured to include, in order from the object side, an objective optical system 10, a first mirror 11, and a second mirror 12, in which the first mirror 11 and the second mirror 12 are disposed in series along the optical axis Z of the objective optical system 10. The first mirror 11 and the second mirror 12 have a first reflective surface 11a and a second reflective surface 12a respectively. Note that FIG. 1 shows the optical axis Z of the objective optical system 10 as optical axis Z1 from the objective optical system 10 to the first reflective surface 11a, as optical axis Z2 from the first reflective surface 11a to the second reflective surface 12a, and as Z3 from the second reflective surface 12a onwards. The optical axis Z1 from the foregoing objective optical system 10 to the first reflective surface 11a and the optical axis Z2 after being reflected by the first reflective surface 11a form one plane.

Each of the first mirror 11 and the second mirror 12 is capable of operating for image blur correction and constitutes a reflective surface optical system 13. The first mirror 11 and the second mirror 12 are disposed in parallel to each other under a reference state in which no image blur correction is performed. Since the first mirror 11 and the second mirror 12 according to the present embodiment are both formed of parallel planar plates, the first reflective surface 11a and the second reflective surface 12a are in parallel to each other when the first mirror 11 and the second mirror 12 are disposed in parallel. The light passed through the objective optical system 10 is reflected at the first reflective surface 11a and incident on the second reflective surface 12a.

As illustrated in FIG. 1, the direction of the optical axis Z1 extending from the objective optical system 10 toward the first reflective surface 11a is defined as +z direction, the direction of the optical axis Z2 extending from the first reflective surface 11a toward the second reflective surface 12a under the reference state in which no image blur correction is performed (to be described later) is defined as +y direction, and one direction orthogonal to the +y direction and the foregoing +z direction is defined as +x direction. The first mirror 11 is disposed so as to be inclined by 45 degrees (°) with respect to the optical axis Z1 within a y-z plane under the reference state.

The optical system according to the present embodiment described above constitutes, as an example, an observation optical system to be applied to an optical device, such as a binocular scope, a field scope, and the like. That is, a type II Porro prism 14, as an erecting optical system, and an eyepiece optical system 15 are disposed in order behind the second reflective surface 12a (direction in which the light from the objective optical system 10 travels), and these prism 14 and eyepiece optical system 15 together with the optical system of the present embodiment constitute an observation optical system. Note that the observation optical system 10 and the eyepiece optical system 15 are schematically illustrated in FIG. 1, and in FIG. 2 to be described later.

Next, image blur correction operations will be described. One image blur correction operation is an operation to turn the first reflective surface 11a (i.e., the first mirror 11) around a turning axis A passing through the intersection between the first reflective surface 11a and the optical axis Z1 and perpendicular to a plane that includes the optical axes Z1 and Z2 before and after being bent by the first reflective surface 11a. The turning of the first reflective surface 11a causes the image location of the objective optical system 10 to be shifted (deflected) in ±y directions. Therefore, when an image observed through the eyepiece optical system 15 is blurred in ±y directions due to vibrations of the optical device, the image blur may be corrected. Note that the operation, including control of the image blur correction, will be described in detail later.

Here, instead of turning the first reflective mirror 11a in the manner described above, the second reflective mirror 12a (i.e., the second mirror 12) may be turned around a turning axis passing through the intersection between the second reflective surface 12a and the optical axis Z2 and perpendicular to a plane that includes the optical axes Z2 and Z3 before and after being bent by the second reflective surface 12a.

Another image blur correction operation that may be performed is an operation to turn the first reflective mirror 11a (i.e., the first mirror 11) around a turning axis B1 passing through the intersection between the first reflective surface 11a and the optical axis Z1 and is deviated from the normal to the first reflective surface 11a, and to turn the second reflective mirror 12a (i.e., the second mirror 12) around a turning axis B2 passing through the intersection between the second reflective surface 12a and the optical axis Z2 and is deviated from the normal to the second reflective surface 12a. The turning axes B1 and B2 are arranged in parallel to each other and the turning operation of the first reflective surface 11a around the turning axis B1 and the turning operation of the second reflective surface 12a around the turning axis B2 are performed in synchronization with each other, that is, in the same direction with the same angular velocity.

As the mechanism for turning the first reflective surface 11a around the turning axis A or for turning the first reflective surface 11a and the second reflective surface 12a around the turning axes B1 and B2 respectively, any known mechanism may be applied and is not limited to a certain mechanism. For example, a configuration in which the mechanism for turning the first reflective surface 11a around the turning axis A is installed in the mechanism for turning the first reflective surface 11a and the second reflective surface 12a around the turning axes B1 and B2 respectively may be applied. In such a configuration, if the foregoing “one image blur correction operation” is performed with the foregoing “another image blur correction operation” being performed, the turning axis A is displaced from the position in the reference state. In contrast, if the “one image blur correction operation” is performed without the “another image blur correction operation” being performed, the tuning axis A is maintained at the same position as that in the reference state. On the other hand, the turning axes B1 and B2 are constant regardless of whether or not the “one image blur correction operation” is performed.

The turning of the reflective surfaces 11a and 12a around the turning axes B1 and B2 respectively described above causes the image location of the objective optical system 10 to be shifted (deflected) in ±x directions. Therefore, when an image observed through the eyepiece optical system 15 is blurred in ±x directions due to vibrations of the optical device, the image blur may be corrected. Note that the operation, including control of the image blur correction, will be described in detail later.

As an example of the turning axis B1 and the turning axis B2 arranged in parallel to each other described above, an embodiment in which they form the same axis, i.e., they are located on one straight line may be applied in the present disclosure.

The turning of the first mirror 11 around the turning axis B1, the turning of the second mirror 12 around the turning axis B2, and the turning of the first mirror 11 around the turning axis A may be implemented by a known mirror holding mechanism and a mirror rotation driving mechanism.

Here, the following conditional expression (1) is satisfied in the optical system according to the present embodiment:

1.05<F/D<2.50 (1)

where:

F is the focal length of the objective optical system 10; and

D is the air equivalent length from the first reflective surface 11a that turns around the turning axis A to the focus position of the objective optical system 10 on the reflective surface optical system 13 side on the optical axis of the objective optical system 10.

Table 27, to be described later, summarizes conditions of numerical ranges defined by conditional expressions (2) to (5) and (10) to (12), in addition to the foregoing conditional expression (1), that is, values of literal portions of the expressions for Examples 1 to 13, to be described later. With respect to the condition of the conditional expression (1), a value when the first reflective surface 11a is turned is indicated on the upper side while a value when the second reflective surface 12a is turned is indicated on the lower side in Table 27.

Since the conditional expression (1) is satisfied, the following effects may be obtained. That is, the value of F/D exceeding the lower limit value of 1.05 makes it easy to prevent interference between the first reflective surface 11a or the second reflective surface 12a and the objective optical system 10. On the other hand, the value of F/D falling below the upper limit value of 2.50 allows the ratio of the image shift amount with respect to the turning angle of the first reflective surface 11a or the second reflective surface 12a to be increased. This allows for a fast response image blur correction.

As the following conditional expression (1)′ is also satisfied in the optical system of the present embodiment, the foregoing effects are more significant:

1.10<F/D<2.30 (1)′.

The following conditional expression (2) is satisfied in the optical system according to the present embodiment (refer to Table 27):

3.50<F/d<6.00 (2)

where:

F is the focal length of the objective optical system 10; and

d is the air equivalent length between the first reflective surface 11a and the second reflective surface 12a on the optical axis of the objective optical system 10.

Since the conditional expression (2) is satisfied, the following effects may be obtained. That is, the value of F/d exceeding the lower limit value of 3.50 makes it easy to prevent interference between the first reflective surface 11a or the second reflective surface 12a and the objective optical system 10. On the other hand, the value of F/d falling below the upper limit value of 6.00 allows the ratio of the image shift amount with respect to the turning angle of the first reflective surface 11a or the second reflective surface 12a to be increased. This allows for a fast response image blur correction.

As the following conditional expression (2)′ is also satisfied in the optical system of the present embodiment, the foregoing effects are more significant:

3.80<F/d<5.50 (2)′.

The following conditional expression (3) is satisfied in the optical system according to the present embodiment (refer to Table 27):

0.70<φDia/H<1.50 (3)

where:

φDia is the maximum effective diameter of the axial light beam on the most object side surface of the objective optical system 10; and

H is the amount of displacement of the optical axis Z by the first reflective surface 11a and the second reflective surface 12a. Note that the value of the maximum effective diameter is twice the value of the axial marginal ray height.

Since the conditional expression (3) is satisfied, the following effects may be obtained. That is, the value of φDia/H exceeding the lower limit value of 0.7 makes it easy to prevent stray light escaping without passing the first reflective surface 11a or the second reflective surface 12a. On the other hand, the value of φDia/H falling below the upper limit value of 1.50 allows the optical system to be made more compact by suppressing the length of the optical system in up-down directions (y direction in FIG. 1).

As the following conditional expression (3)′ is also satisfied in the optical system of the present embodiment, the foregoing effects are more significant:

0.78<φDia/H<1.35 (3)′.

The following conditional expression (12) is satisfied in the optical system according to the present embodiment (refer to Table 27):

0.00<(H−φDia/2)/dm1<0.70 (12)

where:

H is the amount of displacement of the optical axis Z by the first reflective surface 11a and the second reflective surface 12a;

φDia is the maximum effective diameter of the axial light beam on the most object side surface of the objective optical system 10; and

dm1 is the length from the most object side surface of the objective optical system 10 to the first reflective surface 11a on the optical axis of the objective optical system 10.

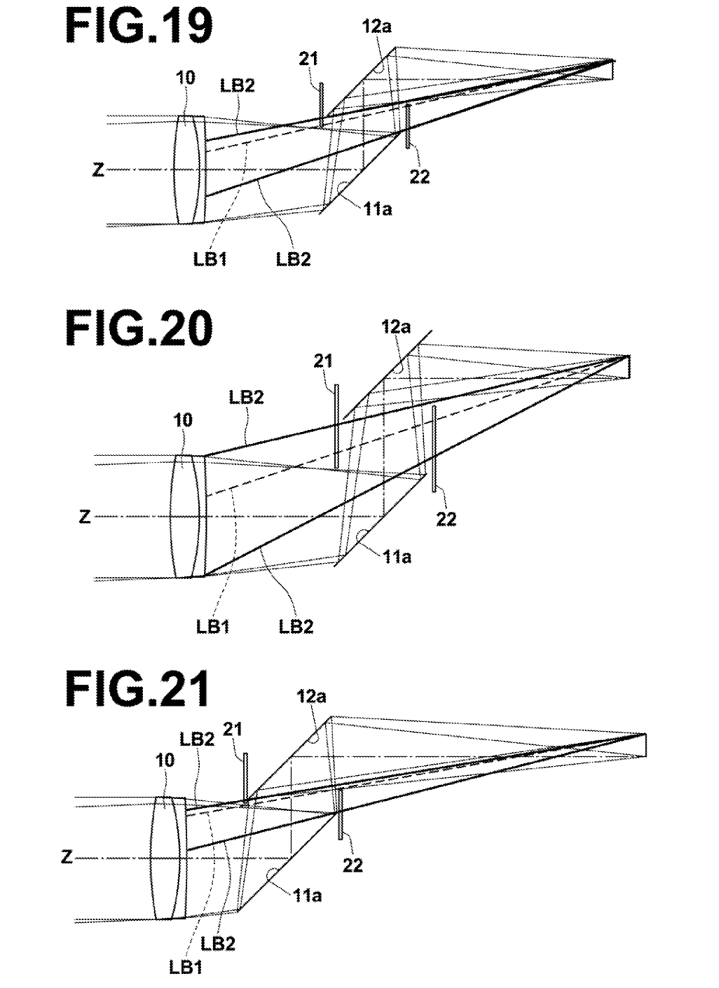

Since the conditional expression (12) is satisfied, a configuration with reduced thicknesses in optical axis shifting directions (directions in which the optical axis Z is displaced by the first reflective surface 11a and the second reflective surface 12a) is possible, while preventing stray light escaping without passing the first reflective surface 11a or the second reflective surface 12a. The reason will be described in detail with reference to FIG. 2 and FIG. 19 to FIG. 21. To avoid complication of FIG. 19 to FIG. 21, H, φDia, and dm1 are shown in FIG. 2.

In the configuration of FIG. 19, if light shielding members 21 and 22 are not provided, light beam LB2 shown by the bold line becomes stray light by simply escaping between the first reflective surface 11a and the second reflective surface 12a. To avoid this, it is conceivable to provide the light shielding members 21 and 22. But, the light shielding members 21 and 22 need to be set at proper positions in up-down directions in the drawing to prevent stray light without intervening into the optical path of the light that should be passed through and causing shading. FIG. 19 shows light beam LB1 which will become stray light is indicated by a broken line. In the configuration of FIG. 19, the light shielding member 21 may shield from the upper side to the light beam LB1 of the light beam LB2 which will become stray light, while the light shielding member 22 may shield from the light beam LB1 to the lower side of the light beam LB2, so that the stray light may be shielded without causing any shading of the light that should be passed through.

FIG. 20 shows a configuration in which the distance between the first reflective surface 11a and the second reflective surface 12a is increased in comparison with the configuration of FIG. 19. Since this configuration increases the amount of displacement H of the optical axis Z, the value of (H−φDia/2)/dm1 is also increased. In the configuration of FIG. 20, if for example, each of the light shielding members 21 and 22 is set at a position where the light beam LB1 shown by a broken line is shielded by each of them within a range in which the optical path of the light beam which should be passed through is not shielded, all stray light may be shielded without causing shading of the light beam which should be passed through. This may increase the setting freedom of the light shielding members 21 and 22 in up-down and left-right directions in the drawing in comparison with the configuration of FIG. 19. That is, this configuration makes it easy to prevent stray light. But, this configuration causes that the size of the reflective surface optical system tends to be increased in a displacement direction of the optical axis Z and thinning of the optical system is difficult.

FIG. 21 shows a configuration in which the first reflective surface 11a and the second reflective surface 12a are placed closer to the objective optical system 10 in comparison with the configuration of FIG. 19. Since this configuration decreases the value of dm1, the value of (H−φDia/2)/dm1 is increased as in the configuration of FIG. 20. In the configuration of FIG. 21, it is difficult to shield the light beam LB1 shown by a broken like by both the light shielding members 21 and 22 without shielding the optical path of the light beam which should be passed through. Thus, this configuration is difficult to prevent stray light.

As described above, to prevent the shading of the foregoing light beam and stray light, it is basically preferable to employ the configuration shown in FIG. 20. In this case, if the value of (H−φDia/2)/dm1 is as large as the upper limit of 0.70 or more, the size of the reflective surface optical system in a displacement direction of the optical axis Z is increased, but the value of (H−φDia/2)/dm1 is kept below the upper limit of 0.70, the size increase described above may be avoided and the entire optical system may eventually be configured compact.

On the other hand, if the value of (H−φDia/2)/dm1 is as small as the lower limit value of 0.00 or less, it is difficult to prevent stray light, but keeping the value above the lower limit makes it easy to prevent stray light.

With respect to the value of (H−φDia/2)/dm1, if the following conditional expression (12)′ is satisfied, and further the following conditional expression (12)″ is satisfied, the foregoing effects are more significant:

0.00<(H−φDia/2)/dm1<0.40 (12)′

0.10<(H−φDia/2)/dm1<0.35 (12)″.

In the optical system according to the present embodiment, a type II Porro prism (hereinafter, simply Porro prism) 14 having an optical surface and an eyepiece optical system 15 are disposed behind the second mirror 12 constituting the second reflective surface 12a, the optical surface located closest to the second reflective surface 12a of those described above is the light incident surface of the Porro prism 14.

The following conditional expression (4) is satisfied in the optical system according to the present embodiment:

1.50<Lair/φDia<3.50 (4)

where:

Lair is the length between the most image side surface of the objective optical system 10 and the light incident surface (optical plane located closest to the second reflective surface 12a) of the Porro prism 14; and

φDia is the maximum effective diameter of the axial light beam on the most object side surface of the objective optical system 10.

Since the conditional expression (4) is satisfied, the following effects may be obtained. That is, the value of Lair/φDia exceeding the lower limit value of 1.50 makes it easy to secure the space for disposing the first reflective surface 11a and the second reflective surface 12a. On the other hand, the value of Lair/φDia falling below the upper limit value of 3.50 allows the overall length of the optical system to be prevented from being too long. As described above, the “optical surface located closest to the second reflective surface 12a” includes the imaging plane of the objective optical system 10. If the conditional expression (4) is satisfied when the imaging plane is the foregoing optical surface, an image blur correction operation by the rotation of the reflective surfaces will be completed before an image of an object is formed by the objective optical system 10.

As the following conditional expression (4)′ is also satisfied in the optical system of the present embodiment, the foregoing effects are more significant:

1.80<Lair/φDia<3.30 (4)′.

The optical system according to the present embodiment constitutes an observation optical system along with an erecting optical system of the Porro prism 14 and the eyepiece optical system 15, in which the surface of the erecting optical system located closest to the second reflective surface 12a is the light incident surface of the Porro prism 14.

In the present embodiment, the first reflective surface 11a and the second reflective surface 12a are inclined by 45° with respect to the optical axis of the objective optical system under a state in which no image blur correction operation is performed. The employment of such configuration allows the structure of the reflective surface optical system to be simplified.

The following conditional expression (5) is satisfied in the optical system according to the present embodiment:

0.30<Dair/F<0.70 (5)

where:

Dair is the length between the most image side surface of the objective optical system 10 and the light incident surface of the Porro prism 14 (surface of the erecting optical system located closest to the second reflective surface 12a); and

F is the focal length of the objective optical system.

Since the conditional expression (5) is satisfied, the following effects may be obtained. That is, the value of Dair/F exceeding the lower limit value of 0.30 makes it easy to secure the space for disposing the first reflective surface 11a and the second reflective surface 12a. On the other hand, the value of Dair/F falling below the upper limit value of 0.70 allows the overall length of the optical system to be prevented from being too long.

As the following conditional expression (5)′ is also satisfied in the optical system of the present embodiment, the foregoing effects are more significant:

0.37<Dair/F<0.62 (5)′.

In the optical system according to the present embodiment, a first light shielding member 21 is disposed between the objective optical system 10 and the second reflective surface 12a, and a second light shielding member 22 is disposed between the Porro prism 14 constituting an erecting optical system and the first reflective surface 11a, as shown in side geometry in FIG. 2. Note that the light shielding members 21 and 22 are omitted in FIG. 1. Hereinafter, positions of the light shielding members 21 and 22 will be described in detail.

A y-z coordinate system is considered to define the foregoing positions. The y-z coordinate system is considered under the reference state in which no image blur correction operation is performed. It is a coordinate system with a plane which includes the optical axis Z before and after being bent by the first reflective surface 11a as the coordinate plane and the position of the optical axis Z on the first reflective surface 11a as the origin, in which the direction of the optical axis Z from the first reflective surface 11a toward the second reflective surface 12a is +y direction and the direction of the optical axis Z from the objective optical system 10 toward the first reflective surface 11a is +z direction.

In the present embodiment, in particular, in Examples 4, 5, 7 to 11, and 13, to be described later, all of the following conditional expressions (6) to (9) are satisfied when the following are assumed in the foregoing y-z coordinate system:

a tip point of the first light shielding member 21 on the optical axis Z side between the objective optical system 10 and the first reflective surface 11a as M (ym, zm);

a tip point of the second light shielding member 22 on the optical axis Z side between the second reflective surface 12a and the erecting optical system 14 as N (yn, zn);

an intersection having the largest y-coordinate of those between rays at a viewing angle of 0 degree and the most image side surface of the objective optical system 10 as P1 (y1, z1);

an intersection having the smallest z-coordinate of those between rays at a viewing angle of 0 degree and the second reflective surface 12a as P2 (y2, z2);

an intersection having the largest z-coordinate of those between rays at a viewing angle of 0 degree and the first reflective surface 11a as P3 (y3, z3); and

an intersection having the smallest y-coordinate of those between rays at a viewing angle of 0 degree and the light incident surface as P4 (y4, z4). Further, conditional expressions (6) and (7) are satisfied in Example 2, the conditional expressions (8) and (9) are satisfied in Examples 3 and 6, and conditional expressions (7) to (9) are satisfied in Example 12. With respect to the conditional expressions (6) to (9) shown in Table 27, the label “OK” indicates that the conditional expression is satisfied. Note that the value of each of the conditional expressions (6) to (9) are shown in Table 28.

y3<ym<y1 (6)

z1<zm<z2 (7)

y2<yn<y4 (8)

z3<zn<z4 (9)

Satisfying the foregoing conditional expressions (6) to (9) makes it easy to prevent stray light escaping without passing the first reflective surface 11a or the second reflective surface 12a. In a case where only one or both of the first and the second light shielding members 21, 22 are provided, if at least one of the conditional expressions (6) to (9) is satisfied, the effect of preventing stray light may be obtained to a certain degree.

In the present embodiment, in particular, in Examples 2, 4, and 5, the following conditional expression (10) is satisfied. Further, the following conditional expression (11) is satisfied in Examples 3 to 6.

0.08<(z2−zm)/(z2−z1)<1.00 (10)

0.08<(zn−z3)/(z4−z3)<1.00 (11)

If the foregoing conditional expression (10) is satisfied, the following effects may be obtained. That is the value of (z2−zm)/(z2−z1) exceeding the lower limit value of 0.08 makes it easy to prevent interference between the second reflective surface 12a and the first light shielding member 21. On the other hand, the value of (z2−zm)/(z2−z1) falling below the upper limit of 1.00 makes it easy to prevent stray light escaping without passing the second reflective surface 12a.

In the optical system of the present embodiment, if the following conditional expression (10)′ and further the conditional expression (10)″ are satisfied, the foregoing effects are more significant.

0.20<(z2−zm)/(z2−z1)<1.00 (10)′

0.27<(z2−zm)/(z2−z1)<1.00 (10)″

If the foregoing conditional expression (11) is satisfied, the following effects may be obtained. That is, the value of (zn−z3)/(z4−z3) exceeding the lower limit value of 0.08 makes it easy to prevent interference between the first reflective surface 11a and the second light shielding member 22. On the other hand, the value of (zn−z3)/(z4−z3) falling below the upper limit value of 1.00 makes it easy to prevent stray light escaping without passing the first reflective surface 11a.

In the optical system of the present embodiment, if the following conditional expression (11)′ and further the conditional expression (11)″ are satisfied, the foregoing effects are more significant.

0.20<(zn−z3)/(z4−z3)<1.00 (11)′

0.27<(zn−z3)/(z4−z3)<1.00 (11)″

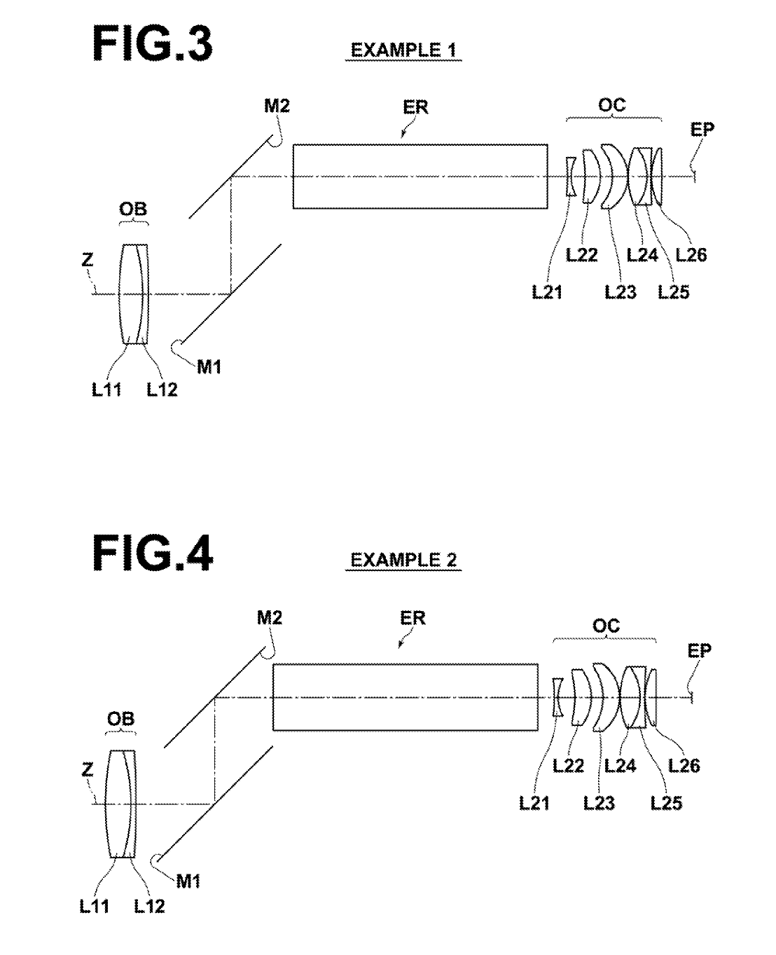

Numerical examples of the optical system of the present disclosure will now be described. FIG. 3 to FIG. 8 and FIG. 12 to FIG. 18 show optical systems of Examples 1 to 13 in cross-section respectively. FIG. 3 to FIG. 8 and FIG. 12 to FIG. 18 illustrate examples of observation optical systems, each including an objective optical system, an erecting optical system, and an eyepiece optical system.

### Example 1

FIG. 3 showing Example 1, illustrates an arrangement of the optical system in infinity focusing state with the left side being the object side and the right side being the image side. FIG. 3 also illustrates the objective optical system 10 schematically illustrated in FIG. 1 as OB, the first reflective surface 11a as M1, the second reflective surface 12a as M2, the erecting optical system constituted by the Porro prism 14 as ER, and the eyepiece optical system 15 as OC. Note that EP in FIG. 3 indicates the eye point. The foregoing description will also be applied to FIG. 4 to FIG. 8 and FIG. 12 to FIG. 18, to be described later.

As an example, the objective optical system OB is composed of a lens L11 having positive refractive power (hereinafter, simply “positive”) and a lens L12 having a negative refractive power (hereinafter, simply “negative”) disposed in order from the object side, as illustrated in FIG. 3. For example, the positive lens L11 is a biconvex lens, while the negative lens L12 is a negative meniscus lens. Note that the positive lens L11 and the negative lens L12 are cemented together.

In the meantime, the eyepiece optical system OC is composed of, for example, a negative lens L21 which is a biconcave lens, a positive lens L22 which is a positive meniscus lens, a positive lens L23 which is a positive meniscus lens, a positive lens L24 which is a biconvex lens, a negative lens L25 which is a negative meniscus lens, and a positive lens L26 which is a biconvex lens disposed in order from the object side. Note that the positive lens L24 and the negative lens L25 are cemented together.

FIG. 3 illustrates the erecting optical system ER as a glass block by stretching out the erecting prism (Porror prism) to make it easy to understand the optical path length.

Basic lens data and specifications of the optical system of Example 1 are shown in Table 1 and Table 2 respectively. In Table 1 and Table 2, the unit of data representing a length is mm and the unit of data representing an angle is degree)(°. Likewise, basic lens data and specifications of the optical systems of Examples 2 to 13 are shown in Table 3 to Table 26. The meanings of the symbols in the tables will be described by way of Example 1, as example, but basically the same applies to Examples 2 to 13.

TABLE 1
Example 1•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 117.258 | 10.00 | 1.51633 | 64.14 |
| 2 | −79.979 | 2.42 | 1.60342 | 38.03 |
| 3 | −352.497 | 35.10 | | |
| 4 | ∞ | 50.00 | | |
| 5 | ∞ | 26.50 | | |
| 6 | ∞ | 108.00 | 1.56883 | 56.04 |
| 7 | ∞ | 8.60 | | |
| 8 | −68.722 | 1.50 | 1.51633 | 64.14 |
| 9 | 16.693 | 5.90 | | |
| 10 | −61.616 | 6.50 | 1.77250 | 49.60 |
| 11 | −18.000 | 5.16 | | |
| 12 | −17.864 | 6.50 | 1.65160 | 58.55 |
| 13 | −16.430 | 0.20 | | |
| 14 | 31.864 | 7.97 | 1.62041 | 60.29 |
| 15 | −20.000 | 1.70 | 1.80518 | 25.42 |
| 16 | 197.651 | 0.20 | | |
| 17 | 25.087 | 4.38 | 1.71299 | 53.87 |
| 18 | −450.437 | 14.00 | | |

TABLE 2
Example 1•Specifications

| | |
|---|---|
| Objective Focal Length F | 200.02 |
| Magnification | 13.96 |
| Aperture | 42.00 |
| Viewing Angle [°] | 4.5 |
| D | 158.10 |
| D | 108.10 |
| d | 50 |
| φDia | 42 |
| H | 50 |
| Lair | 111.60 |
| Dair | 111.60 |
| dm1 | 47.52 |

In the basic lens data of Table 1, Si column in the lens data shown in Table 1 indicates i^{th} surface number in which a number i (i=1, 2, 3, - - - ) is given to each surface in a serially increasing manner toward the image side with the object side surface of the most object side constituent element being taken as the first surface. Ri column indicates the radius of curvature of i^{th} surface and Di column indicates the surface distance between i^{th} surface and (i+l)^{th} surface on the optical axis. Note that the last value of the surface distance is a value of distance from the surface of the positive lens L26 of the eyepiece optical system OC on the eye point EP side to the eye point EP. The sign of the radius of curvature is positive if the surface shape is convex on the object side and negative if it is convex on the image side.

In the basic lens data, the Ndj column indicates the refractive index of j^{th} constituent element from the object side with respect to the d-line (wavelength of 587.6 nm) in which a number j (j=1, 2, 3, - - - ) is given to each constituent element in a serially increasing manner toward the image side with the most object side lens being taken as the first constituent element and the vdj column indicates the Abbe number of j^{th} constituent element with respect to the d-line. Note that the basic lens data also include non-lens elements of the first reflective surface M1, the second reflective surface M2, and three optical surface of the erecting optical system ER, and sections of the radius of curvature column corresponding to these surfaces include the symbol “∞”.

The specifications of Table 2 include values of the foregoing D, d, φDia, H, Lair, Dair, and dm1, in addition to the focal length F (value with respect to the d-line), magnification, aperture, and viewing angle of the objective optical system. As for the value of D, the value when the reflective surface turned around the turning axis A is the first reflective mirror M1 is indicated on the upper side, while the value when the reflective surface turned around the turning axis A is the second reflective mirror M2 is indicated on the lower side. Example 6, to be described later, however, indicates only the case in which the first reflective surface M is turned.

### Example 2

FIG. 4 shows the observation optical system of Example 2 in cross-section. The configuration of the observation optical system of Example 2 is basically the same as that of Example 1. Basic lens data and specifications of the observation optical system of Example 2 are shown in Table 3 and Table 4 respectively.

TABLE 3
Example 2•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 105.720 | 10.00 | 1.51633 | 64.14 |
| 2 | −72.590 | 2.00 | 1.60342 | 38.03 |
| 3 | −317.326 | 30.94 | | |
| 4 | ∞ | 42.00 | | |
| 5 | ∞ | 23.00 | | |
| 6 | ∞ | 104.00 | 1.56883 | 56.04 |
| 7 | ∞ | 6.42 | | |
| 8 | −70.696 | 1.50 | 1.51633 | 64.14 |
| 9 | 14.941 | 6.63 | | |
| 10 | −39.752 | 6.46 | 1.77250 | 49.60 |
| 11 | −18.000 | 4.60 | | |
| 12 | −20.922 | 6.50 | 1.65160 | 58.55 |
| 13 | −16.465 | 0.20 | | |
| 14 | 28.839 | 7.90 | 1.62041 | 60.29 |
| 15 | −20.000 | 1.70 | 1.80518 | 25.42 |
| 16 | 132.753 | 0.20 | | |
| 17 | 23.687 | 4.32 | 1.71299 | 53.87 |
| 18 | −1459.514 | 14.00 | | |

TABLE 4
Example 2•Specifications

| | |
|---|---|
| Objective Focal Length F | 180.04 |
| Magnification | 13.92 |
| Aperture | 42.00 |
| Viewing Angle [°] | 4.5 |
| D | 142.46 |
| D | 100.46 |
| d | 42 |
| φDia | 42 |
| H | 42 |
| Lair | 95.94 |
| Dair | 95.94 |
| dm1 | 42.94 |

### Example 3

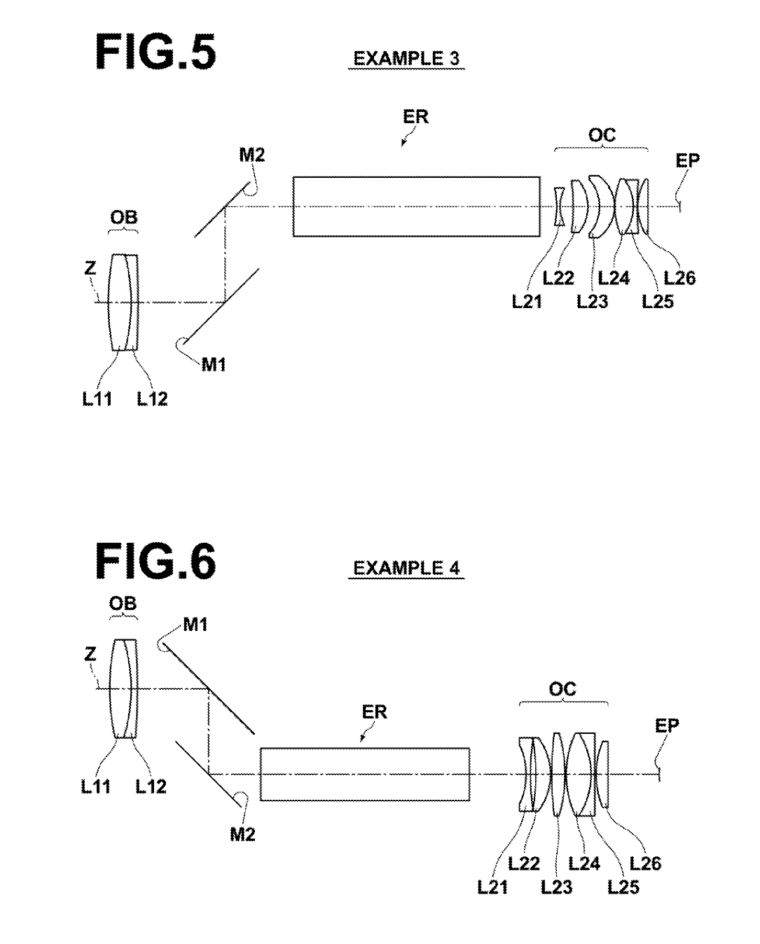

FIG. 5 shows the observation optical system of Example 3 in cross-section. The configuration of the observation optical system of Example 3 is basically the same as that of Example 1. But, a plano-convex lens is used as the positive lens L26 of the eyepiece optical system OC. Basic lens data and specifications of the observation optical system of Example 3 are shown in Table 5 and Table 6 respectively.

TABLE 5
Example 3•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 110.605 | 10.00 | 1.51633 | 64.14 |
| 2 | −81.709 | 3.00 | 1.60342 | 38.03 |
| 3 | −425.633 | 38.16 | | |
| 4 | ∞ | 42.00 | | |
| 5 | ∞ | 30.00 | | |
| 6 | ∞ | 108.00 | 1.51633 | 64.14 |
| 7 | ∞ | 7.42 | | |
| 8 | −39.253 | 1.50 | 1.51633 | 64.14 |
| 9 | 17.966 | 5.70 | | |
| 10 | −96.014 | 6.50 | 1.77250 | 49.60 |
| 11 | −18.000 | 5.12 | | |
| 12 | −17.932 | 6.50 | 1.65160 | 58.55 |
| 13 | −16.762 | 0.20 | | |
| 14 | 31.084 | 8.13 | 1.62041 | 60.29 |
| 15 | −20.000 | 1.70 | 1.80518 | 25.42 |
| 16 | 130.938 | 0.20 | | |
| 17 | 22.970 | 4.46 | 1.71299 | 53.87 |
| 18 | ∞ | 14.00 | | |

TABLE 6
Example 3•Specifications

| | |
|---|---|
| Objective Focal Length F | 200.02 |
| Magnification | 13.96 |
| Aperture | 42.00 |
| Viewing Angle [°] | 4.5 |
| D | 154.34 |
| D | 112.34 |
| d | 42 |
| φDia | 42 |
| H | 42 |
| Lair | 110.16 |
| Dair | 110.16 |
| dm1 | 51.16 |

### Example 4

FIG. 6 shows the observation optical system of Example 4 in cross-section. The observation optical system of Example 4 basically differs from that of Example 1 in that the optical axis Z is bent downward at right angle by the first reflective surface M1. The present example uses a plano-convex lens as the positive lens L26 of the eyepiece optical system OC. Basic lens data and specifications of the observation optical system of Example 4 are shown in Table 7 and Table 8 respectively.

TABLE 7
Example 4•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 74.0000 | 7.00 | 1.51633 | 64.05 |
| 2 | −54.4000 | 2.00 | 1.61293 | 36.95 |
| 3 | −243.3000 | 23.26 | | |
| 4 | ∞ | 28.00 | | |
| 5 | ∞ | 20.00 | | |
| 6 | ∞ | 68.00 | 1.56883 | 56.04 |
| 7 | ∞ | 15.53 | | |
| 8 | −22.6810 | 1.40 | 1.78472 | 25.71 |
| 9 | 75.5060 | 1.75 | | |
| 10 | −66.5420 | 4.80 | 1.69700 | 48.47 |
| 11 | −19.8100 | 0.40 | | |
| 12 | 112.9900 | 4.30 | 1.71300 | 53.90 |
| 13 | −48.1700 | 0.40 | | |
| 14 | 32.3230 | 8.10 | 1.71300 | 53.90 |
| 15 | −24.8260 | 1.20 | 1.78472 | 25.71 |
| 16 | ∞ | 0.50 | | |
| 17 | 29.6010 | 3.90 | 1.62299 | 58.15 |
| 18 | ∞ | 16.60 | | |

TABLE 8
Example 4•Specifications

| | |
|---|---|
| Objective Focal Length F | 130.20 |
| Magnification | 8.00 |
| Aperture | 30.00 |
| Viewing Angle [°] | 6.6 |
| D | 101.89 |
| D | 73.89 |
| d | 28 |
| φDia | 30 |
| H | 28 |
| Lair | 71.26 |
| Dair | 71.26 |
| dm1 | 32.26 |

### Example 5

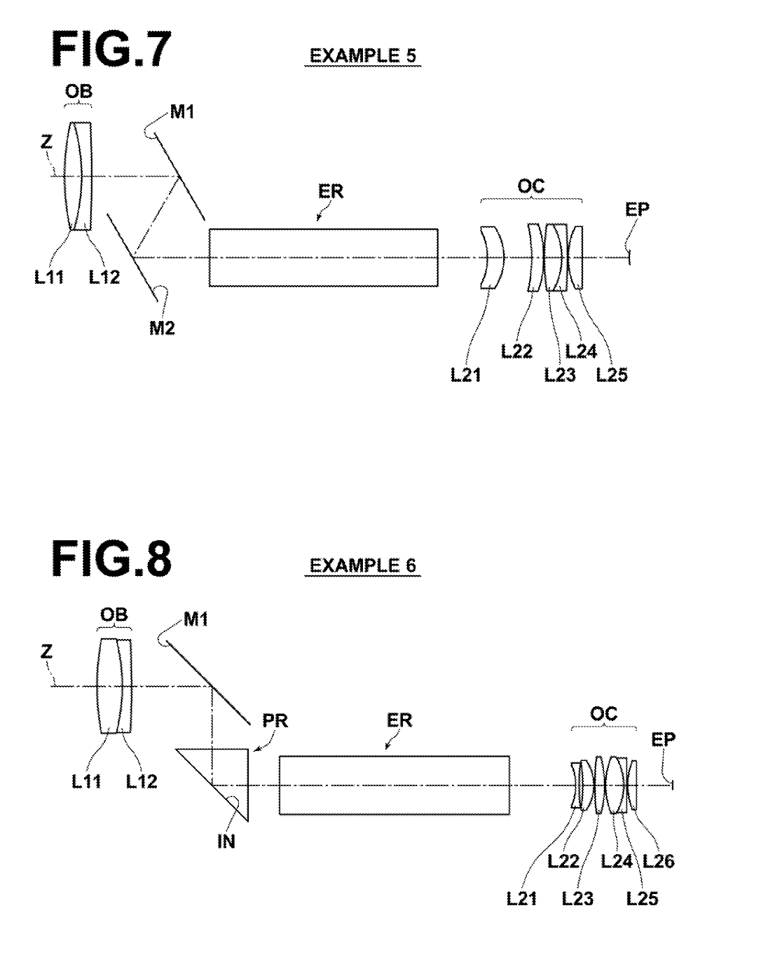

FIG. 7 shows the observation optical system of Example 5 in cross-section. The observation optical system of Example 5 basically differs from that of Example 1 in that the optical axis Z is bent obliquely downward (direction that forms an angle of 30 degrees with a perpendicular direction under the reference state). Therefore, in the observation optical system of Example 5, the first reflective surface M1 is disposed so as to form an angle of 60 degrees under the reference state with the optical axis Z from the observation optical system 10 (refer to FIG. 1).

In comparison with the observation optical system of Example 1, the observation optical system of Example 5 is further different in that the eyepiece optical system OC is composed of five lenses L21 to L25. That is, the eyepiece optical system OC of the present example is composed of a positive lens L21 of a positive meniscus lens, a positive lens L22 of a positive meniscus lens, a positive lens L23 of a biconvex lens, a negative lens L24 of a negative meniscus lens, and a positive lens L25 of a positive meniscus lens disposed in order from the object side.

As describe above, when the amount of displacement by the first reflective surface M1 and the second reflective surface M2 is taken as H and the air equivalent length, on the optical axis Z of the objective optical system OB, between the first reflective surface M1 and the second reflective surface M2 is taken as d, H=d, in the foregoing Examples 1 to 4, while H<d, in Example 5. More specifically, H=(3^{1/2}/2)d. Basic lens data and specifications of the observation optical system of Example 5 are shown in Table 9 and Table 10 respectively.

TABLE 9
Example 5•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 72.038 | 5.12 | 1.51633 | 64.14 |
| 2 | −56.017 | 3.00 | 1.60342 | 38.03 |
| 3 | −362.826 | 26.16 | | |
| 4 | ∞ | 28.00 | | |
| 5 | ∞ | 23.00 | | |
| 6 | ∞ | 68.00 | 1.56883 | 56.04 |
| 7 | ∞ | 14.85 | | |
| 8 | −17.502 | 4.92 | 1.69680 | 55.53 |
| 9 | −16.350 | 8.22 | | |
| 10 | −46.537 | 3.63 | 1.69680 | 55.53 |
| 11 | −30.564 | 0.18 | | |
| 12 | 72.176 | 5.19 | 1.69680 | 55.53 |
| 13 | −20.032 | 1.70 | 1.84666 | 23.78 |
| 14 | −143.121 | 0.20 | | |
| 15 | 21.208 | 4.23 | 1.69680 | 55.53 |
| 16 | −766.250 | 14.00 | | |

TABLE 10
Example 5•Specifications

| | |
|---|---|
| Objective Focal Length F | 137.82 |
| Magnification | 7.90 |
| Aperture | 25.00 |
| Viewing Angle [°] | 6.6 |
| D | 106.87 |
| D | 78.87 |
| d | 28 |
| φDia | 25 |
| H | 24.25 |
| Lair | 77.16 |
| Dair | 77.16 |
| dm1 | 34.28 |

### Example 6

FIG. 8 shows the observation optical system of Example 6 in cross-section. The observation optical system of Example 6 uses a plano-convex lens, as the positive lens L26 of the eyepiece optical system OC and the optical axis Z is bent downward at right angle by the first reflective surface M1, as in Example 4, but a prism PR is used in place of the mirror having the second reflective surface M2 shown in Example 4. In this configuration, the light incident on an internal surface IN of the prism PR after being reflected at the first reflective surface M1 is totally reflected and guided to the erecting optical system ER. That is, in the present embodiment, in internal surface IN of the foregoing prism PR serves as the second reflective surface.

As described above, when the amount of displacement by the first reflective surface M1 and the second reflective surface M2 is taken as H and the air equivalent length, on the optical axis Z of the objective optical system OB, between the first reflective surface M1 and the second reflective surface M2 is taken as d, H=d, in foregoing Examples 1 to 4, while H>d, in Example 6. The value of H changes with the refractive index of the material of the prism PR, but the refractive index is naturally greater than 1 and therefore H>d. Basic lens data and specifications of the observation optical system of Example 6 are shown in Table 11 and Table 12 respectively.

TABLE 11
Example 6•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 80.769 | 8.00 | 1.51633 | 64.14 |
| 2 | −60.308 | 3.00 | 1.62004 | 36.26 |
| 3 | −247.477 | 25.50 | | |
| 4 | ∞ | 20.00 | | |
| 5 | ∞ | 11.50 | 1.56883 | 56.04 |
| 6 | ∞ | 11.50 | 1.56883 | 56.04 |
| 7 | ∞ | 10.00 | | |
| 8 | ∞ | 73.00 | 1.56883 | 56.04 |
| 9 | ∞ | 21.12 | | |
| 10 | −16.284 | 1.00 | 1.78472 | 25.71 |
| 11 | 54.209 | 1.25 | | |
| 12 | −47.774 | 3.50 | 1.69700 | 48.47 |
| 13 | −14.223 | 0.30 | | |
| 14 | 81.121 | 3.10 | 1.71300 | 53.90 |
| 15 | −34.584 | 0.30 | | |
| 16 | 23.206 | 5.80 | 1.71300 | 53.90 |
| 17 | −17.824 | 0.90 | 1.78472 | 25.71 |
| 18 | ∞ | 0.35 | | |
| 19 | 21.252 | 2.80 | 1.62299 | 58.15 |
| 20 | ∞ | 11.50 | | |

TABLE 12
Example 6•Specifications

| | |
|---|---|
| Objective Focal Length F | 140.25 |
| Magnification | 12.03 |
| Aperture | 30.00 |
| Viewing Angle [°] | 5.0 |
| D | 108.79 |
| d | 27.33 |
| φDia | 30 |
| H | 31.5 |
| Lair | 62.83 |
| Dair | 62.83 |
| dm1 | 36.50 |

### Example 7

FIG. 12 shows the observation optical system of Example 7 in cross-section. The configuration of the observation optical system of Example 7 is basically the same as that of Example 1. Basic lens data and specifications of the observation optical system of Example 7 are shown in Table 13 and Table 14 respectively.

TABLE 13
Example 7•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 117.258 | 10.00 | 1.51633 | 64.14 |
| 2 | −79.979 | 2.42 | 1.60342 | 38.03 |
| 3 | −352.497 | 61.00 | | |
| 4 | ∞ | 35.00 | | |
| 5 | ∞ | 21.00 | | |
| 6 | ∞ | 108.00 | 1.56883 | 56.04 |
| 7 | ∞ | 3.20 | | |
| 8 | −68.722 | 1.50 | 1.51633 | 64.14 |
| 9 | 16.693 | 5.90 | | |
| 10 | −61.616 | 6.50 | 1.77250 | 49.60 |
| 11 | −18.000 | 5.16 | | |
| 12 | −17.864 | 6.50 | 1.65160 | 58.55 |
| 13 | −16.430 | 0.20 | | |
| 14 | 31.864 | 7.97 | 1.62041 | 60.29 |
| 15 | −20.000 | 1.70 | 1.80518 | 25.42 |
| 16 | 197.651 | 0.20 | | |
| 17 | 25.087 | 4.38 | 1.71299 | 53.87 |
| 18 | −450.437 | 14.00 | | |

TABLE 14
Example 7•Specifications

| | |
|---|---|
| Objective Focal Length F | 200.02 |
| Magnification | 13.96 |
| Aperture | 42.00 |
| Viewing Angle [°] | 4.5 |
| D | 132.20 |
| D | 97.20 |
| d | 35 |
| φDia | 42 |
| H | 35 |
| Lair | 117.00 |
| Dair | 117.00 |
| dm1 | 73.42 |

### Example 8

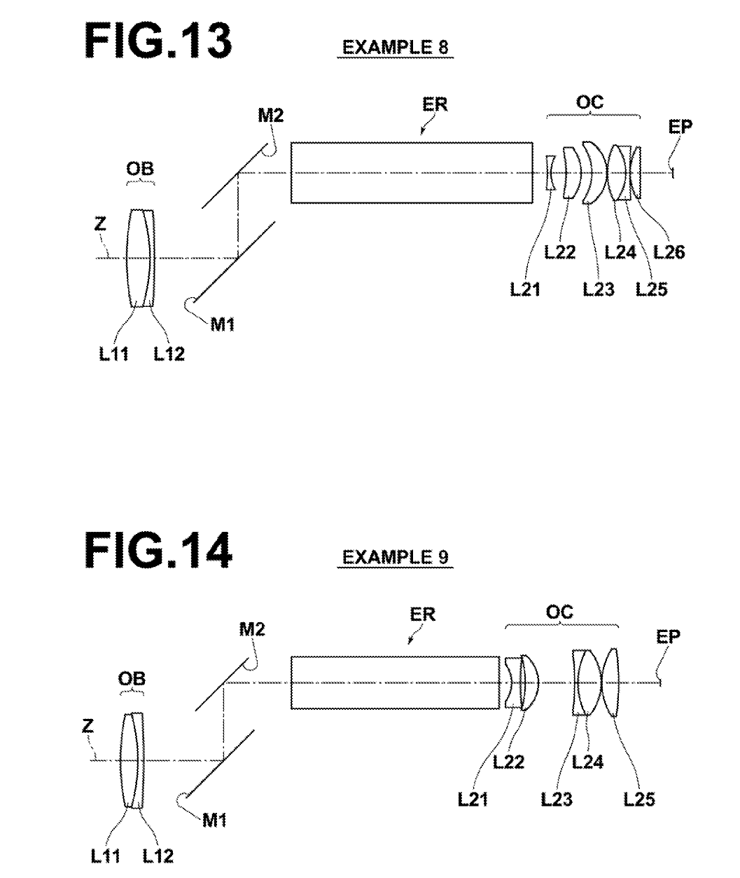

FIG. 13 shows the observation optical system of Example 8 in cross-section. The configuration of the observation optical system of Example 8 is basically the same as that of Example 1. Basic lens data and specifications of the observation optical system of Example 8 are shown in Table 15 and Table 16 respectively.

TABLE 15
Examplc 8•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 105.720 | 10.00 | 1.51633 | 64.14 |
| 2 | −72.590 | 2.00 | 1.60342 | 38.03 |
| 3 | −317.326 | 35.94 | | |
| 4 | ∞ | 37.00 | | |
| 5 | ∞ | 23.00 | | |
| 6 | ∞ | 104.00 | 1.56883 | 56.04 |
| 7 | ∞ | 6.42 | | |
| 8 | −70.696 | 1.50 | 1.51633 | 64.14 |
| 9 | 14.941 | 6.63 | | |
| 10 | −39.752 | 6.46 | 1.77250 | 49.60 |
| 11 | −18.000 | 4.60 | | |
| 12 | −20.922 | 6.50 | 1.65160 | 58.55 |
| 13 | −16.465 | 0.20 | | |
| 14 | 28.839 | 7.90 | 1.62041 | 60.29 |
| 15 | −20.000 | 1.70 | 1.80518 | 25.42 |
| 16 | 132.753 | 0.20 | | |
| 17 | 23.687 | 4.32 | 1.71299 | 53.87 |
| 18 | −1459.514 | 14.00 | | |

TABLE 16
Example 8•Specifications

| | |
|---|---|
| Objective Focal Length F | 180.04 |
| Magnification | 13.92 |
| Aperture | 42.00 |
| Viewing Angle [°] | 4.5 |
| D | 137.46 |
| D | 100.46 |
| d | 37 |
| φDia | 42 |
| H | 37 |
| Lair | 95.94 |
| Dair | 95.94 |
| dm1 | 47.94 |

### Example 9

FIG. 14 shows the observation optical system of Example 9 in cross-section. The observation optical system of Example 9 includes an objective optical system OB having basically the same configuration as that of Example 1. On the other hand, the eyepiece optical system OC is composed of, for example, a negative lens L21 which is a biconcave lens, a positive lens L22 which is a positive meniscus lens, a negative lens L23 which is a negative meniscus lens, a positive lens L24 which is a biconvex lens, and a positive lens L25 which is a biconvex lens disposed in order from the object side. Note that the negative lens L23 and the positive lens L24 are cemented together. Basic lens data and specifications of the observation optical system of Example 9 are shown in Table 17 and Table 18 respectively.

TABLE 17
Example 9•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 77.302 | 6.00 | 1.51633 | 64.14 |
| 2 | −60.847 | 2.00 | 1.60342 | 38.03 |
| 3 | −275.574 | 27.70 | | |
| 4 | ∞ | 27.00 | | |
| 5 | ∞ | 23.50 | | |
| 6 | ∞ | 72.00 | 1.51633 | 64.14 |
| 7 | ∞ | 4.32 | | |
| 8 | −10.9727 | 3.0000 | 1.58913 | 61.13 |
| 9 | 65.9433 | 1.7300 | | |
| 10 | −32.9756 | 4.6000 | 1.83400 | 37.16 |
| 11 | −12.3320 | 12.5000 | | |
| 12 | −73.7530 | 1.1000 | 1.84666 | 23.78 |
| 13 | 23.9830 | 8.1000 | 1.60311 | 60.64 |
| 14 | −17.9269 | 0.2000 | | |
| 15 | 21.8489 | 5.8000 | 1.71299 | 53.87 |
| 16 | −83.8579 | 14.50 | | |

TABLE 18
Example 9•Specifications

| | |
|---|---|
| Objective Focal Length F | 138.95 |
| Magnification | 12.00 |
| Aperture | 30.00 |
| Viewing Angle [°] | 5.0 |
| D | 148.34 |
| D | 121.34 |
| d | 27 |
| φDia | 30 |
| H | 27 |
| Lair | 78.20 |
| Dair | 78.20 |
| dm1 | 35.70 |

### Example 10

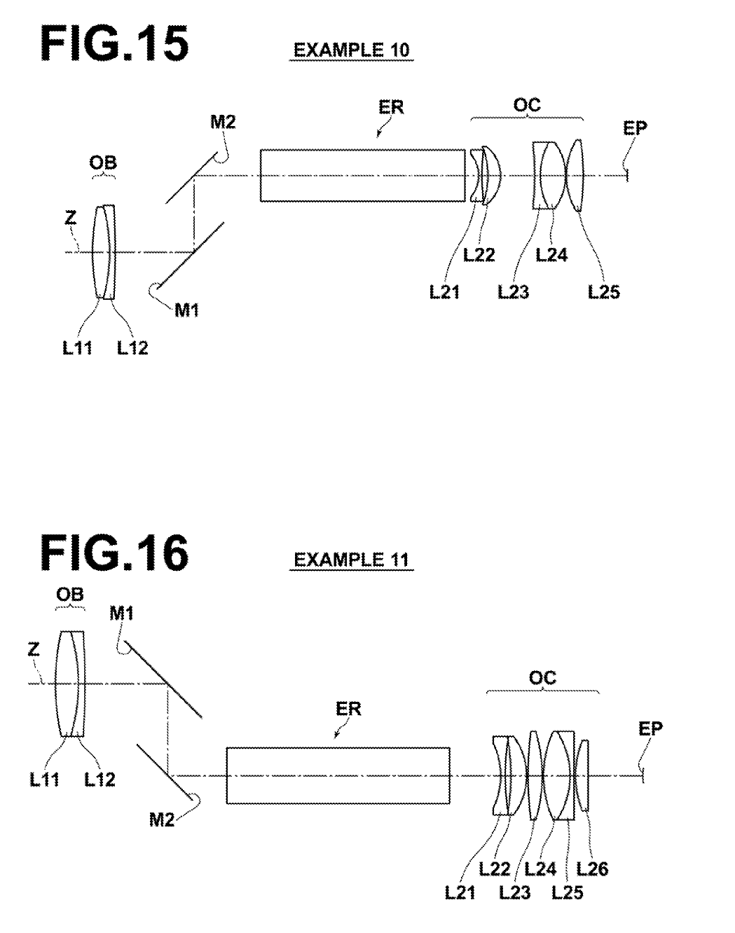

FIG. 15 shows the observation optical system of Example 10 in cross-section. The observation optical system of Example 10 is basically the same as that of Example 9. Basic lens data and specifications of the observation optical system of Example 9 are shown in Table 19 and Table 20 respectively.

TABLE 19
Example 10•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 77.302 | 6.00 | 1.51633 | 64.14 |
| 2 | −60.847 | 2.00 | 1.60342 | 38.03 |
| 3 | −275.574 | 27.70 | | |
| 4 | ∞ | 27.00 | | |
| 5 | ∞ | 23.50 | | |
| 6 | ∞ | 72.00 | 1.51633 | 64.14 |
| 7 | ∞ | 4.78 | | |
| 8 | −11.6932 | 1.2000 | 1.48749 | 70.24 |
| 9 | 93.3244 | 2.0600 | | |
| 10 | −27.9477 | 4.4500 | 1.83400 | 37.16 |
| 11 | −12.9028 | 11.9600 | | |
| 12 | −112.8647 | 2.0000 | 1.84666 | 23.78 |
| 13 | 23.9830 | 8.9500 | 1.56384 | 60.67 |
| 14 | −19.3868 | 0.2100 | | |
| 15 | 24.0412 | 6.0000 | 1.71299 | 53.87 |
| 16 | −80.3044 | 16.20 | | |

TABLE 20
Example 10•Specifications

| | |
|---|---|
| Objective Focal Length F | 137.82 |
| Magnification | 7.90 |
| Aperture | 25.00 |
| Viewing Angle [°] | 6.6 |
| D | 148.34 |
| D | 121.34 |
| d | 27 |
| φDia | 30 |
| H | 27 |
| Lair | 78.20 |
| Dair | 78.20 |
| dm1 | 35.70 |

### Example 11

FIG. 16 shows the observation optical system of Example 11 in cross-section. The observation optical system of Example 11 includes an objective optical system OB having basically the same configuration as that of Example 1. On the other hand the eyepiece optical system OC is composed of, for example, a negative lens L21 which is a biconcave lens, a positive lens L22 which is a positive meniscus lens, a positive lens L23 which is a biconvex lens, a positive lens L24 which is a biconvex lens, a negative lens L25 which is a plano-concave lens, and a positive lens L26 which is a plano-convex lens disposed in order from the object side. Note that the positive lens L24 and the negative lens L25 are cemented together. Basic lens data and specifications of the observation optical system of Example 9 are shown in Table 21 and Table 22 respectively.

TABLE 21
Example 11•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 74.0000 | 7.00 | 1.51633 | 64.05 |
| 2 | −54.4000 | 2.00 | 1.61293 | 36.95 |
| 3 | −243.3000 | 25.26 | | |
| 4 | ∞ | 28.00 | | |
| 5 | ∞ | 18.00 | | |
| 6 | ∞ | 68.00 | 1.56883 | 56.04 |
| 7 | ∞ | 15.53 | | |
| 8 | −22.6810 | 1.40 | 1.78472 | 25.71 |
| 9 | 75.5060 | 1.75 | | |
| 10 | −66.5420 | 4.80 | 1.69700 | 48.47 |
| 11 | −19.8100 | 0.40 | | |
| 12 | 112.9900 | 4.30 | 1.71300 | 53.90 |
| 13 | −48.1700 | 0.40 | | |
| 14 | 32.3230 | 8.10 | 1.71300 | 53.90 |
| 15 | −24.8260 | 1.20 | 1.78472 | 25.71 |
| 16 | ∞ | 0.50 | | |
| 17 | 29.6010 | 3.90 | 1.62299 | 58.15 |
| 18 | ∞ | 16.60 | | |

TABLE 22
Example 11•Specifications

| | |
|---|---|
| Objective Focal Length F | 130.20 |
| Magnification | 8.00 |
| Aperture | 30.00 |
| Viewing Angle [°] | 6.6 |
| D | 99.89 |
| D | 71.89 |
| d | 28 |
| φDia | 30 |
| H | 28 |
| Lair | 71.26 |
| Dair | 71.26 |
| dm1 | 34.26 |

### Example 12

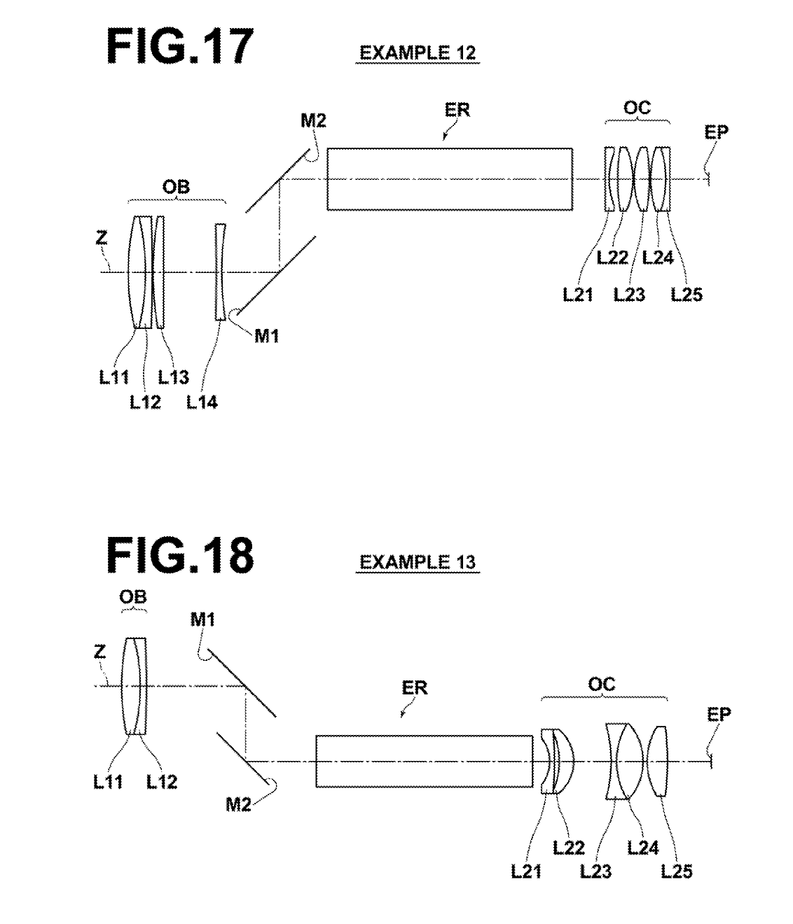

FIG. 17 shows the observation optical system of Example 12 in cross-section. In the observation optical system of Example 12, the objective optical system OB is composed of, for example, a positive lens L11 which is a biconvex lens, a negative lens L12 which is a negative meniscus lens, a positive lens L13 which is a plano-convex lens, and a negative lens L14 which is a negative meniscus lens disposed in order from the object side. Note that the positive lens L11 and the negative lens L12 are cemented together.

The eyepiece optical system OC is composed of, for example, a negative lens L21 which is a plano-concave lens, a positive lens L22 which is a biconvex lens, a positive lens L23 which is a biconvex lens, a positive lens L24 which is a biconvex lens, and a negative lens L25 which is a plano-concave lens disposed in order from the object side. Note that the positive lens L24 and the negative lens L25 are cemented together. Basic lens data and specifications of the observation optical system of Example 12 are shown in Table 23 and Table 24 respectively.

TABLE 23
Example 12•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 91.1040 | 6.50 | 1.51680 | 64.20 |
| 2 | −91.1040 | 2.50 | 1.62004 | 36.30 |
| 3 | −930.2018 | 0.30 | | |
| 4 | 119.4300 | 4.00 | 1.51680 | 64.20 |
| 5 | ∞ | 19.80 | | |
| 6 | −677.5000 | 2.00 | 1.51680 | 64.20 |
| 7 | 112.7600 | 21.78 | | |
| 8 | ∞ | 35.00 | | |
| 9 | ∞ | 18.00 | | |
| 10 | ∞ | 92.00 | 1.56883 | 56.06 |
| 11 | ∞ | 12.43 | | |
| 12 | ∞ | 1.50 | 1.78472 | 25.72 |
| 13 | 28.5017 | 3.10 | | |
| 14 | 65.0376 | 5.80 | 1.62041 | 60.31 |
| 15 | −29.5088 | 0.42 | | |
| 16 | 29.5088 | 5.80 | 1.62041 | 60.31 |
| 17 | −65.0376 | 0.42 | | |
| 18 | 37.5150 | 5.70 | 1.62041 | 60.31 |
| 19 | −37.5150 | 1.50 | 1.78472 | 25.72 |
| 20 | ∞ | 14.60 | | |

TABLE 24
Example 12•Specifications

| | |
|---|---|
| Objective Focal Length F | 184.92 |
| Magnification | 10.00 |
| Aperture | 40.00 |
| Viewing Angle [°] | 5.0 |
| D | 115.91 |
| D | 80.91 |
| d | 35 |
| φDia | 40 |
| H | 35 |
| Lair | 74.78 |
| Dair | 74.78 |
| dm1 | 56.88 |

### Example 13

FIG. 18 shows the observation optical system of Example 13 in cross-section. The observation optical system of Example 13 includes an objective optical system OB having basically the same configuration as that of Example 1. On the other hand, the eyepiece optical system OC is composed of, for example, a negative lens L21 which is a negative meniscus lens, a positive lens L22 which is a positive meniscus lens, a negative lens L23 which is a biconcave lens, a positive lens L24 which is a biconvex lens, and a positive lens L25 which is a biconvex lens disposed in order from the object side. Note that the negative lens L23 and the positive lens L24 are cemented together. In the present example, the optical axis Z is bent downward at right angle by the first reflective surface M1, as in Example 4. Basic lens data and specifications of the observation optical system of Example 13 are shown in Table 25 and Table 26 respectively.

TABLE 25
Example 13•Lens Data

| Si | Ri | Di | Ndj | vdj |
|---|---|---|---|---|
| (Surface | (Radius of | (Surface | (Refractive | (Abbe |
| Number) | Curvature) | Distance) | Index) | Number) |
| 1 | 80.1758 | 6.23 | 1.51633 | 64.14 |
| 2 | −60.3310 | 2.08 | 1.60342 | 38.03 |
| 3 | −305.5402 | 32.82 | | |
| 4 | ∞ | 25.00 | | |
| 5 | ∞ | 23.50 | | |
| 6 | ∞ | 72.00 | 1.56883 | 56.04 |
| 7 | ∞ | 5.67 | | |
| 8 | | | | |
| 9 | | | | |
| 10 | −12.4101 | 4.80 | 1.48749 | 70.24 |
| 11 | −123.4286 | 0.40 | | |
| 12 | −23.4300 | 4.30 | 1.83400 | 37.16 |
| 13 | −13.8720 | 0.40 | | |
| 14 | −44.9221 | 8.10 | 1.84666 | 23.78 |
| 15 | 24.3841 | 1.20 | 1.62041 | 60.29 |
| 16 | −18.8488 | 0.50 | | |
| 17 | 22.2688 | 3.90 | 1.71299 | 53.87 |
| 18 | −101.7709 | 16.60 | | |

TABLE 26
Example 13•Specifications

| | |
|---|---|
| Objective Focal Length F | 144.40 |
| Magnification | 10.00 |
| Aperture | 30.00 |
| Viewing Angle [°] | 6.0 |
| D | 106.43 |
| D | 81.43 |
| d | 25 |
| φDia | 30 |
| H | 25 |
| Lair | 81.32 |
| Dair | 81.32 |
| dm1 | 41.13 |

Table 27 summarizes conditions of numerical ranges defined by conditional expressions (1) to (5) and (10) to (12), that is, values of literal portions of the expressions for Examples 1 to 13. In addition, the values of each of the conditional expressions (6) to (9) are shown in Table 28.

TABLE 27

| | | Example | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| C/E | 1.05 < F/D < 2.50 | 1.27 | 1.26 | 1.30 | 1.28 | 1.29 | 1.29 | 1.51 | 1.31 | 0.94 | 0.94 | 1.30 | 1.60 | 1.36 |
| (1) | | 1.85 | 1.79 | 1.78 | 1.76 | 1.75 | — | 2.06 | 1.79 | 1.15 | 1.15 | 1.81 | 2.29 | 1.77 |
| (2) | 3.50 < F/d < 6.00 | 4.00 | 4.29 | 4.76 | 4.65 | 4.92 | 5.13 | 5.71 | 4.87 | 5.15 | 5.15 | 4.65 | 5.28 | 5.78 |
| (3) | 0.70 < φ Dia/H < 1.50 | 0.84 | 1.00 | 1.00 | 1.07 | 1.03 | 0.95 | 1.20 | 1.14 | 1.11 | 1.11 | 1.07 | 1.14 | 1.20 |
| (4) | 1.50 < Lair/φ Dia < 3.50 | 2.66 | 2.28 | 2.26 | 2.38 | 3.09 | 2.34 | 2.79 | 2.28 | 2.61 | 2.61 | 2.38 | 1.87 | 2.71 |
| (5) | 0.30 < Dair/F< 0.70 | 0.56 | 0.53 | 0.47 | 0.55 | 0.56 | 0.50 | 0.58 | 0.53 | 0.56 | 0.56 | 0.55 | 0.40 | 0.56 |
| (6) | y3 < ym < y1 | — | OK | — | OK | OK | — | OK | OK | OK | OK | OK | NG | OK |
| (7) | z1 < zm < z2 | — | OK | — | OK | OK | — | OK | OK | OK | OK | OK | OK | OK |
| (8) | y2 < yn < y4 | — | — | OK | OK | OK | OK | OK | OK | OK | OK | OK | OK | OK |
| (9) | z3 < zn < z4 | — | — | OK | OK | OK | OK | OK | OK | OK | OK | OK | OK | OK |
| (10) | 0.08 < (z2 − zm)/ | — | 0.31 | — | 0.24 | 0.27 | — | 0.09 | 0.08 | 0.11 | 0.11 | 0.20 | 0.38 | 0.09 |
| | (z2 − z1) < 1.00 | | | | | | | | | | | | | |
| (11) | 0.08 < (zn − z3)/ | — | — | 0.34 | 0.31 | 0.40 | 0.09 | 0.48 | 0.32 | 0.01 | 0.01 | 0.62 | 0.50 | 0.28 |
| | (z4 − z3) < 1.00 | | | | | | | | | | | | | |
| (12) | 0.00 < (H − φ Dia/2)/ | 0.61 | 0.49 | 0.41 | 0.40 | 0.34 | 0.35 | 0.19 | 0.33 | 0.34 | 0.34 | 0.38 | 0.26 | 0.24 |
| | dm1 < 0.70 | | | | | | | | | | | | | |

Note:
C/E represents Conditional Expression

TABLE 28

| | Example | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| y1 | 20.47 | 20.45 | 20.40 | 14.59 | 12.16 | 14.50 | 20.47 | 20.45 | 14.66 | 14.66 | 14.58 | 15.59 | 14.64 |
| y2 | 37.25 | 28.63 | 28.74 | 18.30 | 16.65 | 22.09 | 23.53 | 23.65 | 17.28 | 17.28 | 18.56 | 24.61 | 15.47 |
| y3 | 15.09 | 14.97 | 14.75 | 10.60 | 9.26 | 10.57 | 12.62 | 14.44 | 10.46 | 10.46 | 10.39 | 11.87 | 10.10 |
| y4 | 41.41 | 32.93 | 30.00 | 21.75 | 19.15 | 24.60 | 26.96 | 27.91 | 20.90 | 20.90 | 21.75 | 27.86 | 18.94 |
| ym | — | 20.00 | — | 13.40 | 11.65 | — | 17.22 | 18.96 | 13.15 | 13.15 | 13.44 | 16.45 | 12.37 |
| yn | — | — | 30.00 | 20.30 | 18.29 | 22.72 | 24.63 | 26.05 | 18.70 | 18.70 | 20.74 | 24.69 | 17.92 |
| z1 | −35.70 | −31.60 | −38.65 | −23.70 | −26.37 | −25.93 | −61.59 | −36.60 | −28.09 | −28.09 | −25.70 | −20.70 | −33.17 |
| z2 | −12.75 | −13.37 | −13.26 | −9.70 | −18.39 | −9.41 | −11.46 | −13.37 | −9.72 | −9.72 | −9.44 | −10.39 | −9.53 |
| z3 | 15.09 | 14.97 | 14.75 | 10.60 | 5.35 | 10.57 | 12.62 | 14.44 | 10.46 | 10.46 | 10.39 | 11.87 | 10.10 |
| z4 | 26.50 | 23.00 | 33.31 | 20.00 | 9.00 | 21.50 | 21.00 | 23.00 | 23.50 | 23.50 | 18.00 | 18.00 | 23.50 |
| zm | — | −19.00 | — | −13.00 | −20.50 | — | −15.82 | −15.26 | −11.75 | −11.75 | −12.73 | −14.33 | −11.56 |
| zn | — | — | 21.00 | 13.50 | 6.80 | 11.50 | 16.68 | 17.20 | 10.55 | 10.55 | 15.13 | 14.91 | 13.83 |

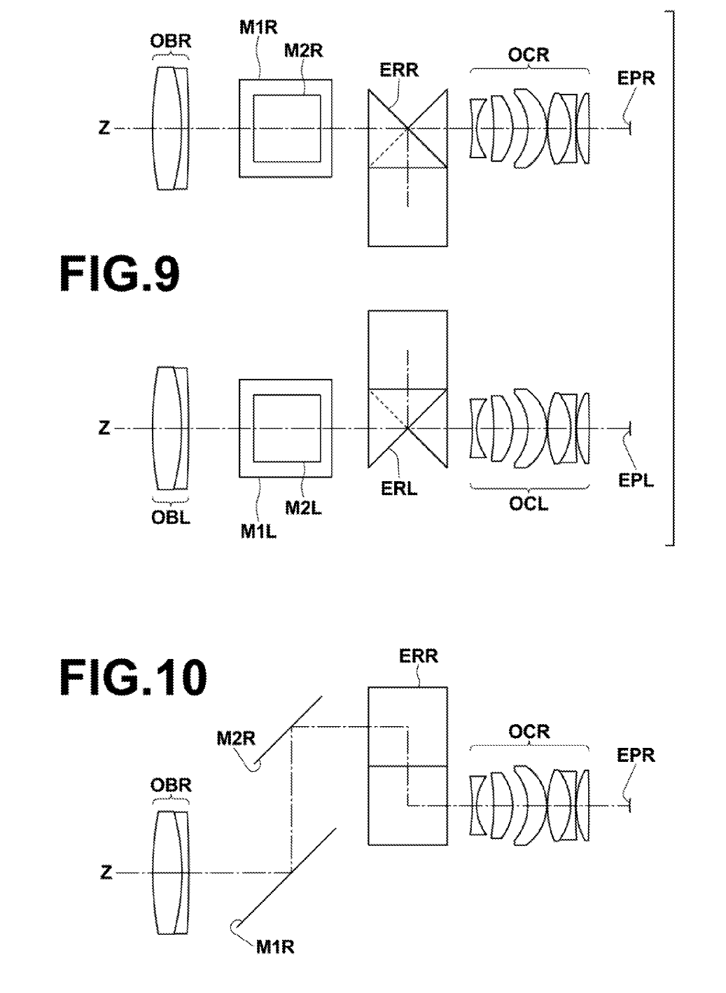

Next, an optical apparatus according to one embodiment of the present disclosure will be described with reference to FIG. 9 to FIG. 11. As an example, the optical apparatus is a binocular scope. FIG. 9 and FIG. 10 illustrate a planar shape and a lateral shape of the optical system of the binocular scope respectively. In FIG. 9 and FIG. 10, each optical element is given the same reference symbol as that used in FIG. 3 to FIG. 8 and FIG. 12 to FIG. 18, with a suffix “R” for right eye and a suffix “L” for left eye.

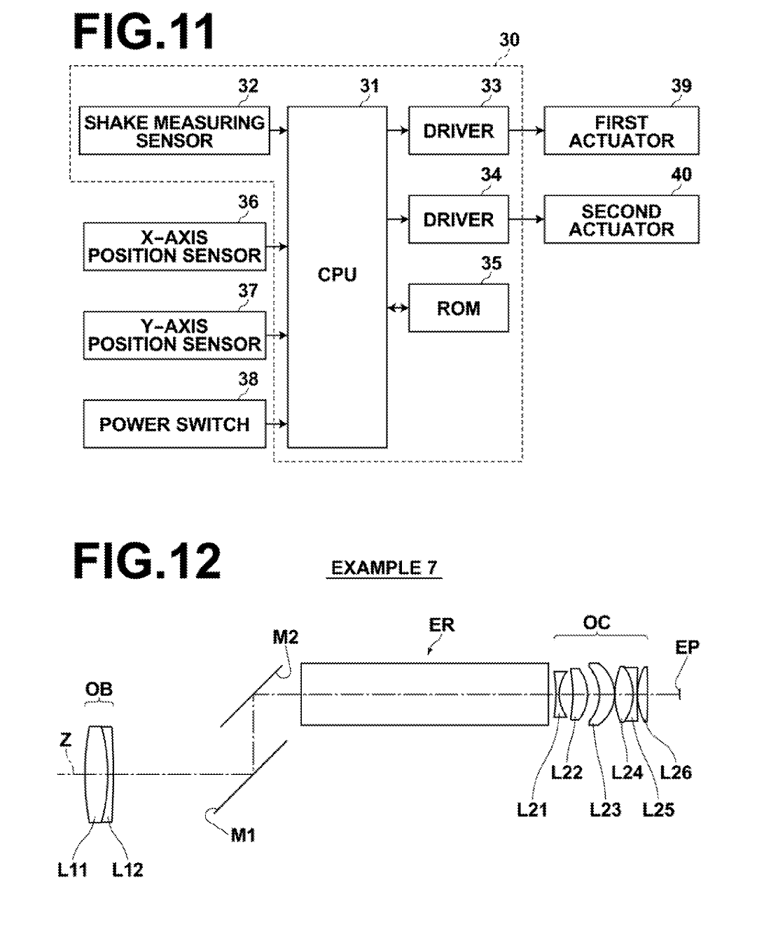

FIG. 11 is a block diagram, illustrating an image blur correction circuit and surrounding circuits of the foregoing binocular scope. As illustrated, the image blur correction control circuit 30 includes a CPU (Central Processing Unit) 31. A shake measuring sensor 32 that measures shake amounts around x-axis and y-axis of the binocular scope 30, drivers 33 and 34 that respectively drive a first actuator 39 and a second actuator 40, to be described later, and a ROM (Read Only Memory) 35 which has a control program stored therein are connected to the CPU 31.

Apart from the image blur correction control circuit 30, an x-axis position sensor 36, a y-axis position sensor 37, and a power switch 38 are attached to the binocular scope, which are connected to the CPU 31 respectively. Hereinafter, electrical and mechanical configurations will be described with reference to FIG. 1, instead of FIG. 9 and FIG. 10 which illustrate optical elements.

The binocular scope further includes a first actuator 39 and a second actuator 40. The first actuator 39 includes a movable portion, not shown, which is moved, for example, by a flat-coil type voice coil motor in y-axis directions, and the movement of the movable portion causes the first mirror 11 to turn around the turning axis A via, for example, a link mechanism, not shown. The second actuator 40 also includes a movable portion, not shown, which is moved, for example, by a flat-coil type voice coil motor in x-axis directions, and the movement of the movable portion causes the first mirror 11 and the second mirror 12 to synchronously turn around the turning axes B1 and B2 respectively.

The x-axis position sensor 36 described above detects the position of the movable portion of the second actuator 40 in x-axis directions and inputs a position detection signal indicating the detected position to the CPU 31. The y-axis position sensor 37 detects the position of the movable portion of the first actuator 39 in y-axis directions and inputs a position detection signal indicating the detected position to the CPU 31.

Next, an image blur correction operation controlled by the image blur correction control circuit 30 will be described. The image blur correction control circuit 30 is activated by an ON operation of the power switch 38. The shake measuring sensor 32 detects shaking around x-axis and y-axis of the binocular scope 30 and inputs a shake detection signal to the CPU 31. Based on the shake detection signal from the shake measuring sensor 32, the position of the movable portion of the second actuator 40 detected by the x-axis position sensor 36, and the position of the movable portion of the first actuator 39 detected by the y-axis position sensor 37, the CPU 31 controls the drivers 33 and 34 to drive the first actuator 39 and the second actuator 40 such that the image blur of the optical image is corrected.

If the binocular scope is shaken in a direction around the x-axis and an image blur is caused in a pitch direction, the CPU 31 causes the movable portion of the first actuator 39 to move in a y-axis direction. The movement of the movable portion is made in a direction and by an amount corresponding to the direction and amount of the image blur, and the first mirror 11 is turned around the turning axis A in accordance therewith. This causes the direction of the optical axis Z3 shown in FIG. 1 to be deflected within the y-z plane, whereby the image blur in the pitch direction is corrected.

If the binocular scope is shaken in a direction around the y-axis and an image blur is caused in a yaw direction, the CPU 31 causes the movable portion of the second actuator 40 to move in an x-axis direction. The movement of the movable portion is made in a direction and by an amount corresponding to the direction and amount of the image blur, and the first mirror 11 and the second mirror 12 are turned around the turning axes B1 and B2 concurrently in accordance therewith. This causes the direction of the optical axis Z3 shown in FIG. 1 to be deflected within the x-z plane, whereby the image blur in the yaw direction is corrected.

So far the present disclosure has been described by way of embodiments and examples. It should be appreciated that the present disclosure is not limited to the foregoing embodiments and examples, and various modifications may be made. For example, in place of the erecting optical system composed of the type II Porro prism 14, an erecting optical system composed of another prism, such as a type I Porro prism, a Dach prism, or the like may be applied. It is effective, however, to apply the type II Porro prism to keep the length of the observation optical system short in a longitudinal direction (z direction in FIG. 1). Further, the values of radius of curvature, surface distance, refractive index, Abbe number, aspherical surface coefficient, and the like of each lens constituting the objective optical system OB and the eyepiece optical system OC are not limited to those shown in each example, and these may take other values.

What is claimed is:

1. An optical system, comprising, in order from the object side, an objective optical system and a reflective surface optical system disposed along the optical axis of the objective optical system, wherein:
the reflective surface optical system comprises a first reflective surface and a second reflective surface disposed in parallel to each other;
the first reflective surface includes a straight line perpendicular to the optical axis of the objective optical system and is capable of taking a reference state in which the first reflective surface is disposed such that a plane is formed by the optical axis after being reflected by the first reflective surface and the optical axis of the objective optical system;
the apparatus is configured such that the image location of the objective optical system is moved by one of the following operations:
a turning operation of either one of the first reflective surface and the second reflective surface around a turning axis A passing through the intersection between the reflective surface and the optical axis and is perpendicular to the plane that includes the optical axes before and after being bent by the reflective surface;
a turning operation of the first reflective surface and the second reflective surface synchronously around turning axes B1 and B2, each passing through the intersection between each corresponding reflective surface and the optical axis, being deviated from the normal to each corresponding reflective surface, and being arranged in parallel to each other; and
both of the turning operations; and
the following conditional expression is satisfied:
1.05<F/D<2.50 (1)
where:
F is the focal length of the objective optical system; and
D is the air equivalent length from the reflective surface that turns around the turning axis A to the focus position of the objective optical system on the reflective surface optical system side on the optical axis of the objective optical system.

2. An optical system, comprising, in order from the object side, an objective optical system and a reflective surface optical system disposed along the optical axis of the objective optical system, wherein:
the reflective surface optical system comprises a first reflective surface and a second reflective surface disposed in parallel to each other;
the first reflective surface includes a straight line perpendicular to the optical axis of the objective optical system and is capable of taking a reference state in which the first reflective surface is disposed such that a plane is formed by the optical axis after being reflected by the first reflective surface and the optical axis of the objective optical system;
the apparatus is configured such that the image location of the objective optical system is moved by one of the following operations:
a turning operation of either one of the first reflective surface and the second reflective surface around a turning axis A passing through the intersection between the reflective surface and the optical axis and is perpendicular to the plane that includes the optical axes before and after being bent by the reflective surface;
a turning operation of the first reflective surface and the second reflective surface synchronously around turning axes B1 and B2, each passing through the intersection between each corresponding reflective surface and the optical axis, being deviated from the normal to each corresponding reflective surface and, being arranged in parallel to each other; and
both of the turning operations; and
the following conditional expression is satisfied:
3.50<F/d<6.00 (2)
where:
F is the focal length of the objective optical system; and
d is the air equivalent length between the first reflective surface and the second reflective surface on the optical axis of the objective optical system.

3. An optical system, comprising, in order from the object side, an objective optical system and a reflective surface optical system disposed along the optical axis of the objective optical system, wherein:
the reflective surface optical system comprises a first reflective surface and a second reflective surface disposed in parallel to each other;
the first reflective surface includes a straight line perpendicular to the optical axis of the objective optical system and is capable of taking a reference state in which the first reflective surface is disposed such that a plane is formed by the optical axis after being reflected by the first reflective surface and the optical axis of the objective optical system;
the apparatus is configured such that the image location of the objective optical system is moved by one of the following operations:
a turning operation of either one of the first reflective surface and the second reflective surface around a turning axis A passing through the intersection between the reflective surface and the optical axis and is perpendicular to the plane that includes the optical axes before and after being bent by the reflective surface;
a turning operation of the first reflective surface and the second reflective surface synchronously around turning axes B1 and B2, each passing through the intersection between each corresponding reflective surface and the optical axis, being deviated from the normal to each corresponding reflective surface and, being arranged in parallel to each other; and
both of the turning operations; and
the following conditional expression is satisfied:
0.70<φDia/H<1.50 (3)
where:
φDia is the maximum effective diameter of the axial light beam on the most object side surface of the objective optical system; and
H is the amount of displacement of the optical axis by the first reflective surface and the second reflective surface.

4. An optical system, comprising, in order from the object side, an objective optical system and a reflective surface optical system disposed along the optical axis of the objective optical system, wherein:
the reflective surface optical system comprises a first reflective surface and a second reflective surface disposed in parallel to each other;
the first reflective surface includes a straight line perpendicular to the optical axis of the objective optical system and is capable of taking a reference state in which the first reflective surface is disposed such that a plane is formed by the optical axis after being reflected by the first reflective surface and the optical axis of the objective optical system;
the apparatus is configured such that the image location of the objective optical system is moved by one of the following operations:
a turning operation of either one of the first reflective surface and the second reflective surface around a turning axis A passing through the intersection between the reflective surface and the optical axis and is perpendicular to the plane that includes the optical axes before and after being bent by the reflective surface;
a turning operation of the first reflective surface and the second reflective surface synchronously around turning axes B1 and B2, each passing through the intersection between each corresponding reflective surface and the optical axis, being deviated from the normal to each corresponding reflective surface, and being arranged in parallel to each other; and
both of the turning operations; and
the following conditional expression is satisfied:
0.00<(H−φDia/2)/dm1<0.70 (12)
where:
H is the amount of displacement of the optical axis by the first reflective surface and the second reflective surface;
φDia is the maximum effective diameter of the axial light beam on the most object side surface of the objective optical system; and
dm1 is the length from the most object side surface of the objective optical system to the first reflective surface on the optical axis of the objective optical system.

5. The optical system of claim 1, wherein the following conditional expression is satisfied:
3.50<F/d<6.00 (2)
where:
F is the focal length of the objective optical system; and
d is the air equivalent length between the first reflective surface and the second reflective surface on the optical axis of the objective optical system.

6. The optical system of claim 5, wherein the following conditional expression is satisfied:
0.70<φDia/H<1.50 (3)
where:
φDia is the maximum effective diameter of the axial light beam on the most object side surface of the objective optical system; and
H is the amount of displacement of the optical axis by the first reflective surface and the second reflective surface.

7. The optical system of claim 1, wherein the following conditional expression is satisfied:
0.70<φDia/H<1.50 (3)
where:
φDia is the maximum effective diameter of the axial light beam on the most object side surface of the objective optical system; and
H is the amount of displacement of the optical axis by the first reflective surface and the second reflective surface.

8. The optical system of claim 1, wherein the following conditional expression is satisfied:
0.00<(H−φDia/2)/dm1<0.70 (12)
where:
H is the amount of displacement of the optical axis by the first reflective surface and the second reflective surface;
φDia is the maximum effective diameter of the axial light beam on the most object side surface of the objective optical system; and
dm1 is the length from the most object side surface of the objective optical system to the first reflective surface on the optical axis of the objective optical system.

9. The optical system of claim 2, wherein the following conditional expression is satisfied:
0.70<φDia/H<1.50 (3)
where:
φDia is the maximum effective diameter of the axial light beam on the most object side surface of the objective optical system; and
H is the amount of displacement of the optical axis by the first reflective surface and the second reflective surface.

10. The optical system of claim 3, wherein the following conditional expression is satisfied:
0.00<(H−φDia/2)/dm1<0.70 (12)
where:
H is the amount of displacement of the optical axis by the first reflective surface and the second reflective surface;
φDia is the maximum effective diameter of the axial light beam on the most object side surface of the objective optical system; and
dm1 is the length from the most object side surface of the objective optical system to the first reflective surface on the optical axis of the objective optical system.

11. The optical system of claim 1, wherein:
at least one optical plane is present further to the side of the image location formed by the objective optical system than the member constituting the second reflective surface; and
the following conditional expression is satisfied:
1.50<Lair/φDia<3.50 (4)
where:
Lair is the length between the most image side surface of the objective optical system and the optical plane located closest to the second reflective surface among the optical planes; and
φDia is the maximum effective diameter of the axial light beam on the most object side surface of the objective optical system.

12. The optical system of claim 1, wherein the first reflective surface and the second reflective surface are inclined by 45° with respect to the optical axis of the objective optical system under a state in which no turning operation is performed.

13. An observation optical system, comprising the optical system of claim 1, and an eyepiece optical system disposed on the side of the second reflective surface where image location formed by the objective optical system is located.

14. The observation optical system of claim 13, where an erecting optical system is disposed between the second reflective surface and the eyepiece optical system.

15. The observation optical system of claim 14, where the erecting optical system is composed of a type II Porro prism.

16. The observation optical system of claim 14, wherein the following conditional expression is satisfied:
0.30<Dair/F<0.70 (5)
where:
Dair is the length between the most image side surface of the objective optical system and the surface of the erecting optical system located closest to the second reflective surface; and
F is the focal length of the objective optical system.

17. The observation optical system of claim 14, wherein:
at least either one of a first light shielding member to be disposed between the objective optical system and the second reflective surface and a second light shielding member to be disposed between the first reflective surface and the erecting optical system is provided; and
at least one of the following conditional expressions is satisfied when the following are assumed:
in a coordinate system with a surface which includes the optical axes before and after being bent by the first reflective surface under the reference state as the coordinate surface and the position of the optical axis on the first reflective surface as the origin, in which the direction of the optical axis from the first reflective surface toward the second reflective surface is +y direction and the direction of the optical axis from the objective optical system toward the first reflective surface is +z direction,
a tip point of the first light shielding member on the optical axis side between the objective optical system and the first reflective surface as M (ym, zm);
a tip point of the second light shielding member on the optical axis side between the second reflective surface and the erecting optical system as N (yn, zn);
an intersection having the largest y-coordinate of those between rays at a viewing angle of 0 degree and the most image side surface of the objective optical system as P1 (y1, z1);
an intersection having the smallest z-coordinate of those between rays at a viewing angle of 0 degree and the second reflective surface as P2 (y2, z2);
an intersection having the largest z-coordinate of those between rays at a viewing angle of 0 degree and the first reflective surface as P3 (y3, z3); and
an intersection having the smallest y-coordinate of those between rays at a viewing angle of 0 degree and the surface of the erecting optical system located closest to the second reflective surface as P4 (y4, z4),
y3<ym<y1 (6)
z1<zm<z2 (7)
y2<yn<y4 (8)
z3<zn<z4 (9).

18. The observation optical system of claim 17, wherein at least one of the following conditional expressions is satisfied:
0.08<(z2−zm)/(z2−z1)<1.00 (10)
0.08<(zn−z3)/(z4−z3)<1.00 (11)

19. An optical apparatus, comprising the observation optical system of claim 13.

20. The optical apparatus of claim 19, wherein the optical apparatus is a binocular scope.
